(19) United States
(12) Patent Application Publication
(10) Pub. No.: US 2026/0055947 A1
(43) Pub. Date: Feb. 26, 2026

(54) ICE MAKER

(71) Applicant: Kuper, LLC, Beverly Hills, CA (US)

(72) Inventors: Hani Khodadadi, West Vancouver (CA); Babak Loghmani, North Vancouver (CA); Ali Raiszadeh, North Vancouver (CA); Ali Baladi, Richmond (CA)

(73) Assignee: Kuper, LLC, Beverly Hills, CA (US)

(21) Appl. No.: 19/179,592

(22) Filed: Apr. 15, 2025

Related U.S. Application Data
(60) Provisional application No. 63/634,036, filed on Apr. 15, 2024.

(51) Int. Cl. F25C 1/18; F25C 1/10; F25C 1/22

(52) U.S. Cl. CPC F25C 1/18; F25C 1/10; F25C 1/22

(57) ABSTRACT

An ice maker includes an ice forming mold having a first mold surface defining a first cavity. A fluid conduit is configured to carry a cooling fluid for cooling the first mold surface. A water outlet is positioned and configured to stream water over the first mold surface. A heatable shaping mold includes a second mold surface defining a second cavity. One or both of the shaping mold and the ice forming mold are moveable relative to each other from an ice forming position, wherein the shaping mold is spaced apart from the ice forming mold, and a shaping position, wherein the shaping mold and the ice forming mold are abutted such that the second cavity of the shaping mold and the first cavity of the ice forming mold define an ice piece shape. A method of forming clear ice pieces is also provided.

### RELATED APPLICATION

This application claims priority to and the benefit of U.S. Provisional Patent Application No. 63/634,036, filed Apr. 15, 2024, pending, the entirety of which is herein incorporated by reference.

### FIELD OF THE DISCLOSURE

The current disclosure is directed to an automatic ice maker, specifically focusing on a device designed to produce clear ice in various shapes.

### BACKGROUND

While it is well known to make ice pieces with ice making machines, the ice pieces often include air bubbles, or other impurities, which may adversely affect the aesthetic appearance of the ice pieces. To solve this problem, some ice making machines provide for a flow of fluid over an ice forming member. Such systems, however, typically do not provide a repetitive, shaped ice piece, such as a large sphere.

### SUMMARY OF THE PRESENT DISCLOSURE

The present invention is defined by the following claims, and nothing in this section should be considered to be a limitation on those claims.

In one aspect, one embodiment of an ice maker is configured for making clear ice spheres. The ice maker may include without limitation an ice forming mold, an ice shaping mold, a cooling mechanism, a water supply system and an ice separation system and a sphere ice sorting mechanism.

In one embodiment, a method of making an ice piece applies a uniform stream of cold water over an ice forming mold, which is cooled by a cooling fluid to create a fully clear ice piece. To achieve the desired ice forming conditions, the cooling fluid may be used to lower the temperature of a mold surface, while positioning the mold at a predetermined angular position to facilitate the flow of the water stream over the mold surface. The mold will perform a rotating and/or waving action at various time intervals within a predetermined range in order to even out the flow of water onto the mold and/or uniform ice formation. The mold surface may be maintained at a predetermined temperature with the cooling fluid. The cooling fluid may be directed around the mold so as to maintain a uniform cold temperature of the mold surface.

Water is continuously streamed over the mold surface to form the ice piece layer-by-layer in a controlled manner. The process is continued until the mold is completely filled with clear ice. The process of streaming water using a water stream controller ensures that the water flow is uniform, without air bubbles in the mold. The formed ice piece may then be shaped with a tool, such as a heatable shaping mold, to define a final shape of the ice piece.

In one aspect, one embodiment of an ice maker includes an ice forming mold having a first mold surface defining a first cavity opening laterally outwardly when the ice forming mold is in an ice forming position. A liquid conduit is configured to carry a liquid for cooling the first mold surface. A water outlet is positioned above, and configured to continuously stream water over the first mold surface. A heatable shaping mold includes a second mold surface defining a second cavity. One or both of the shaping mold and the ice forming mold are moveable relative to each other wherein the shaping mold is spaced apart from the ice forming mold, and a shaping position, wherein the shaping mold and the ice forming mold are abutted such that the second cavity of the shaping mold and the first cavity of the ice forming mold define an ice piece shape. In one embodiment, the ice piece has a spherical shape.

In another embodiment, an ice maker includes an ice forming mold having a first mold surface including a first portion defining a hemispherical shape opening laterally outwardly when the ice forming mold is in an ice forming position and a second portion having a convex shape. A fluid conduit is configured to carry a fluid for cooling the first mold surface. A water outlet is positioned and configured to continuously stream water over at least the first mold surface.

In another aspect, a method of making ice pieces includes orienting an ice forming mold in an ice forming position, wherein the ice forming mold has a first mold surface defining a first cavity opening laterally outwardly, circulating a fluid through a conduit and thereby cooling the first mold surface with the fluid, streaming cold water over the first mold surface, forming a formed ice piece on the first mold surface of the ice forming mold, pressing a heated shaping mold against the formed ice piece and thereby melting the formed ice piece to define a finished ice piece, moving the heated shaping mold away from the finished ice piece, heating the ice forming mold, rotating the ice forming mold, and releasing the finished ice piece from the ice forming mold.

The various embodiments of the ice maker and method of making ice pieces, provide significant advantages over other ice makers and methods. For example, and without limitation, the disclosed ice maker is capable of making relatively large, clear spherical ice pieces.

A disclosed, this application is generally directed to a device for producing transparent ice. In various embodiments, the device includes several distinct parts, such as the mold cooling system, the control and regulation system for water entering the molds, the ice production molds, and the final shaping mechanism of the ice. Additionally, the device or system may include a mold movement mechanism that allows molds to be placed in different forms, an ice separation mechanism from the mold, an ice dryer system, ice trays for storing ice, a control system, and a body.

The foregoing paragraphs have been provided by way of general introduction, and are not intended to limit the scope of the following claims. The various preferred embodiments, together with further advantages, will be best understood by reference to the following detailed description taken in conjunction with the accompanying drawings.

### BRIEF DESCRIPTION OF THE DRAWINGS

FIG. 1 is a perspective view, in partial cross section, of one embodiment of an ice forming mold for making ice.

FIG. 2A is a front view of the ice forming mold shown in FIG. 1.

FIG. 2B is a cross-sectional view of the ice forming mold taken along line 2B-2B in FIG. 2A.

FIG. 3 is a perspective view, in progressive, partial cross section, of another embodiment of an ice forming mold assembly, having a plurality of molds.

FIG. 4 is a rear cross-sectional view of the embodiment of the ice forming mold assembly shown in FIG. 3.

FIG. 5 is a perspective view the ice forming mold of FIG. 3.

FIG. 6 is an end view of the ice forming mold shown in FIG. 5.

FIGS. 7A-D are front, top, rear, and bottom views of the ice forming mold shown in FIG. 5.

FIG. 8 is a perspective view of the position control mechanism for the ice forming mold.

FIG. 9 is a front view of the position control mechanism shown in FIG. 8.

FIG. 10 is a front view of an ice shaping mold applied to an ice forming mold.

FIG. 11 is a cross-sectional side view of the ice shaping mold applied to the ice forming mold taken along line 11-11 in FIG. 10.

FIG. 12 is a cross-sectional view of one embodiment of an ice maker.

FIGS. 13A-C are a perspective and cross-sectional views of another embodiment of an ice maker.

FIG. 14 is a side schematic view of one embodiment of an ice-forming unit for inclusion in the ice maker of FIGS. 13A-C, including molds, forming molds, a splash guard, ice storage trays, and related ice moving and storage mechanisms.

FIG. 15 is a partial cross-sectional view of a mold unit which may be utilized in the ice maker of FIGS. 13A-C.

FIG. 16 is a cross-sectional view of the mold unit shown in FIG. 15.

FIGS. 17A and B are partial perspective and side views of one embodiment of a mold forming unit, or ice forming mold which may be utilized in the ice maker of FIGS. 13A-C.

FIG. 18 is an enlarged partial cross-sectional view of a mold unit having a one-piece mold and a section of the mold where the water conditioning and supply passageways are easily visible.

FIG. 19 is a perspective view of one embodiment of a water collection reservoir, or distribution channel, embodied in the mold unit of FIG. 18.

FIGS. 20A and 20B are respectively exploded cross-sectional and exploded perspective views of an ice forming mold and an ice forming mold assembly which may be utilized in the ice maker of FIGS. 13A-C.

FIG. 21 is a front perspective view of the assembly of FIG. 20B.

FIG. 22 is a rear perspective view of the assembly of FIG. 21.

FIG. 23 is a top view of the assembly in FIG. 21.

FIG. 24 is a cross-sectional view of the assembly in FIG. 21.

FIGS. 25A-D are perspective, front, cross sectional, and rear views of one embodiment of a mold portion or assembly which may be utilized in the ice maker of FIGS. 13A-C.

FIG. 26 is an exploded view of first and second mold portions or assemblies which may be utilized in the ice maker of FIGS. 13A-C.

FIG. 27A-E are exemplary cross-sectional views of one embodiment of an ice forming mold sequentially forming an ice piece, along with an ice shaping mold forming a spherical ice piece.

FIG. 28 is a cross-sectional side view showing an exemplary water path through an alternative ice forming mold for forming a cubic ice piece.

FIG. 29 shows exemplary cross-sectional views of another embodiment of an ice forming mold sequentially forming a cubic ice piece.

FIGS. 30A-C shows three different multi-cavity ice forming mold assemblies: spherical, cubic, and cylindrical, respectively.

FIG. 31 is a cross-sectional side view showing an exemplary water path through an ice forming mold for forming a cylindrical-shaped ice piece.

FIG. 32 shows exemplary cross-sectional views of another embodiment of an ice forming mold sequentially forming a cylindrical ice piece.

FIG. 33 is a perspective view of an assembly that enables both rotary and/or linear motion movement of the ice forming mold and the ice shaping mold which may be utilized in the ice maker of FIGS. 13A-C.

FIG. 34 is an exploded perspective view of a rotary coupling for supply of a liquid (cooling and/or heating) to the ice forming molds which may be utilized in the ice maker of FIGS. 13A-C.

FIG. 35 is a perspective view of an ice collection tray for sorting the ice pieces with levers, along with a system for collecting the water coming out of molds positioned thereabove, which may be utilized in the ice maker of FIG. 12.

FIG. 36 is an exemplary partial side view of the ice collection tray shown in FIG. 35.

FIG. 37A is a perspective view of another ice collection tray, along with a water collection system for collecting water from molds positioned thereabove, which may be utilized in the ice maker of FIG. 12.

FIG. 37B is an enlarged, partial view of a mechanism for operating the ice collection tray shown in FIG. 37.

FIGS. 38A-C are perspective, exploded and cross-sectional side views of an ice storage system, which may be utilized in the ice maker of FIGS. 13A-C.

FIGS. 39A-C shows front and cross-sectional views of three ice forming mold assemblies for forming ice pieces in three different shapes: spherical, cube, and cylindrical.

FIG. 40 is a side cross-sectional view of an ice shaping mold applied to melt ice to form a finished ice piece, which may be utilized in the ice maker of FIGS. 13A-C.

FIG. 41 is a cross-sectional view illustrating the discharge of a clear ice piece from an ice forming mold, which may be utilized in the ice maker of FIGS. 13A-C.

FIG. 42 are side views illustrating different angles of the mold or mold assembly, which may be utilized in the ice maker of FIGS. 13A-C.

FIG. 43 is an exploded view of an ice-making unit that includes mechanisms, molds, a forming mold, a collection tray, and an ice sorter, which may be utilized in the ice maker of FIGS. 13A-C.

FIGS. 44A-D are perspective and side views of one embodiment of an alternative ice production unit.

FIG. 45 is an exemplary water flow diagram.

FIG. 46 is an exemplary liquid flow diagram.

### DESCRIPTION OF THE PREFERRED EMBODIMENTS

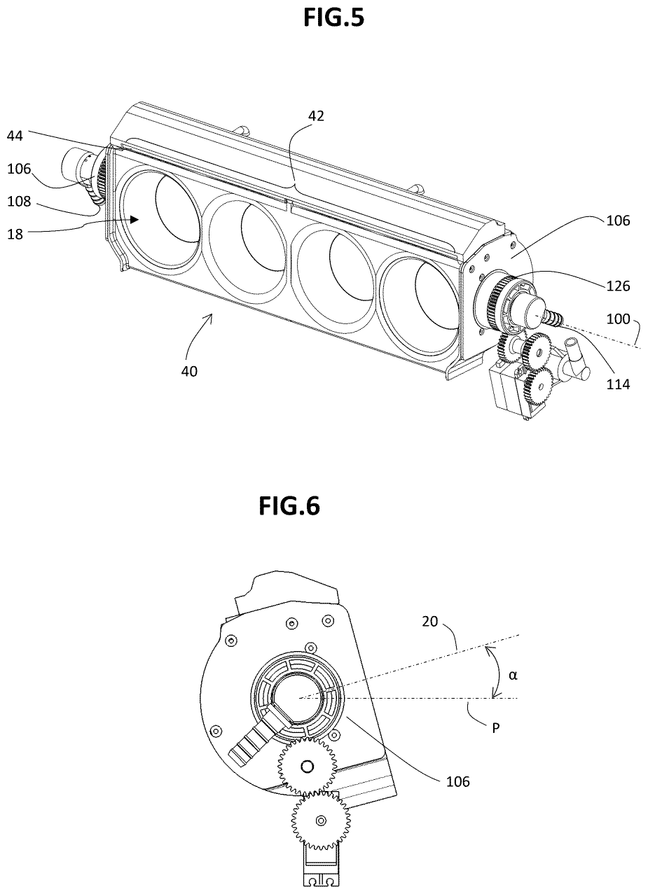

It should be understood that the term “plurality,” as used herein, means two or more. The term “longitudinal” as used herein means of or relating to length or the lengthwise direction 2, for example between opposite ends of an ice forming mold 10, as illustrated generally in FIG. 3. The term “horizontal” means a direction parallel to the ground, or orthogonal to the direction of gravity. The terms “lateral” and “transverse” as used herein, means situated on, directed toward or running from front to back, and refers to a lateral direction 4 transverse or orthogonal to the longitudinal direction, for example between the front and rear of the ice forming mold 10. In this way, the longitudinal or lengthwise direction 2 and the lateral or transverse direction 4 define a plane, for example, a horizontal plane (P), orthogonal to the direction of gravity, as illustrated in FIG. 6. The term “coupled” means connected to or engaged with whether directly or indirectly, for example with an intervening member, and does not require the engagement to be fixed or permanent, although it may be fixed or permanent (or integral), and includes both mechanical and electrical connection. The terms “first,” “second,” and so on, as used herein are not meant to be assigned to a particular component so designated, but rather are simply referring to such components in the numerical order as addressed, meaning that a component designated as “first” may later be a “second” such component, depending on the order in which it is referred. For example, a “first” component may be later referred to as a “second” component depending on the order in which they are referred. It should also be understood that designation of “first” and “second” does not necessarily mean that the two components or values so designated are different, meaning for example a first component may be the same as a second component, with each simply being applicable to separate but identical components.

The following disclosure is directed to ice-making machines, otherwise referred to as ice makers 8, and techniques and methods for creating ice pieces, and shaped ice pieces in particular. In general, the ice makers disclosed herein produce transparent, or clear, ice pieces, including for example and without limitation clear spherical ice pieces.

The process of transparent ice production involves various components, including for example and without limitation a cooling system, a water supply system for molds, a movement/rotation mechanism, a final shaping system, a mold separation system, and optionally, an ice storage unit.

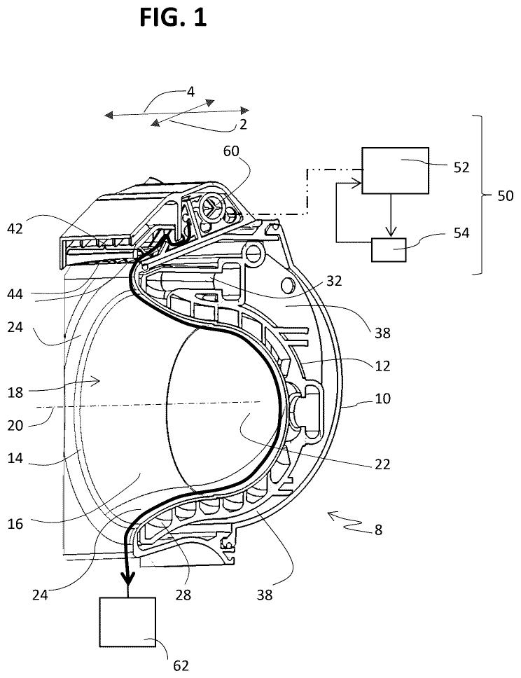

Referring to FIGS. 1-7D, one embodiment of an ice maker 8 includes an ice forming mold 10 having a housing, or body 12, and a shell or forming member 14 defining a mold surface 16. The forming member 14 may be made of metal, or other suitable material for forming ice thereon. For example, the forming member 14 may be made of at metal comprising stainless steel, copper, or aluminum. Alternatively, the forming member may be made of a plastic, such as food-grade Nylon 12 (polished or coated with a nickel plating). In some embodiments, the forming member 14 may comprise an insert or sheath that sits within the forming mold 10. A thermal conductivity of the forming member 14 may be selected or calibrated to moderate the formation of ice thereon, as rapid ice formation will not achieve the desired clear crystalline structure and/or may result in cracking of the ice.

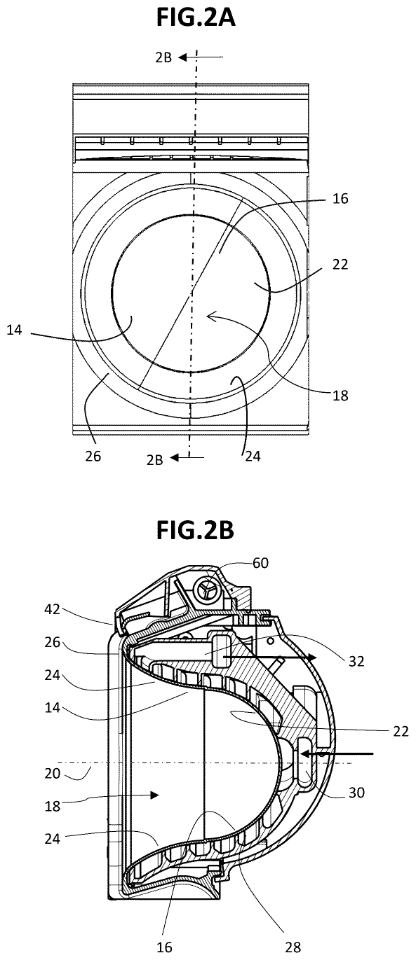

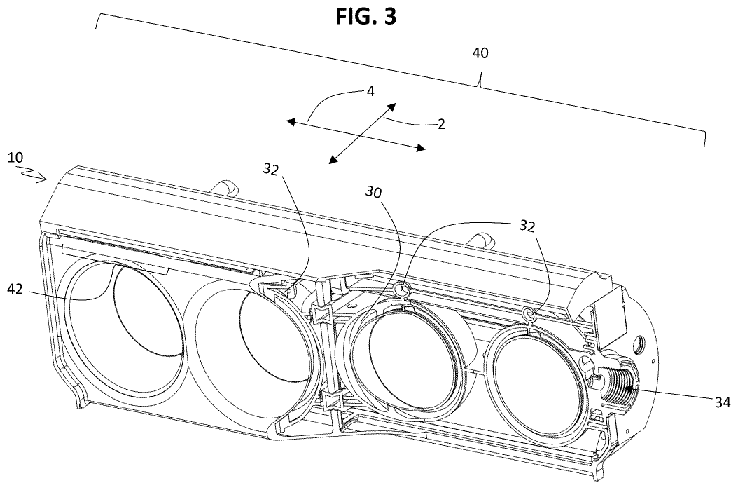

The forming member 14, and the mold surface 16 in particular, define a cavity 18 having an ice forming profile. In one embodiment, the ice forming mold surface 16 defines a cavity 18 opening laterally outwardly when the ice forming mold is in an ice forming position, as shown for example in FIG. 6. In one embodiment, the cavity 18 is symmetrical about a laterally extending axis 20, projecting out of the cavity 18, as shown in FIGS. 1, 2B, and 6 . . . . The ice forming mold surface 16 may have a first, interior portion 22 configured with a concave surface as shown in FIGS. 1 and 2A-B. In one embodiment, the first interior portion 22 of the mold surface defines a hemispherical shape, or other shapes defined by a curve rotated 360 degrees about the axis 20. In one embodiment, the curve is defined by a radius 20 mm<R<40 mm, and in one embodiment 32 mm; however, it is envisioned that radii of many other sizes are within the scope of the present disclosure. additionally, it should be understood that other shapes, including polygonal shapes, may be formed by the first portion 22. The mold surface also includes a second portion 24, which extends laterally outwardly from the first portion 22. The second portion includes a convex shape, or shoulder, extending laterally and radially outwardly from the first portion 22 and having a peripheral lip portion 26 defining a mouth of the cavity 18. It should be understood that the second portion, or a portion thereof, may also include a linear surface, which extends laterally and radially outwardly.

As used herein, the term “laterally outwardly” refers to the opening of the cavity 18 in the lateral direction 4 (relatively to the longitudinal direction 2), and also to the outwardly curved convex surface of the second portion 24, which forms a transition between the first portion 22, internal to the cavity 18, and the portion of the mold surface adjacent to the section portion 24, external to the cavity 18. Notably, as explained below, the outwardly (relative to the laterally extending axis 20) curved surface of the second portion 24 facilitates adhesion of the water flowing over the mold surface thereon, so that the water enters the depths of the cavity 18, without separating from the mold surface due to gravitational forces, causing it to fall below.

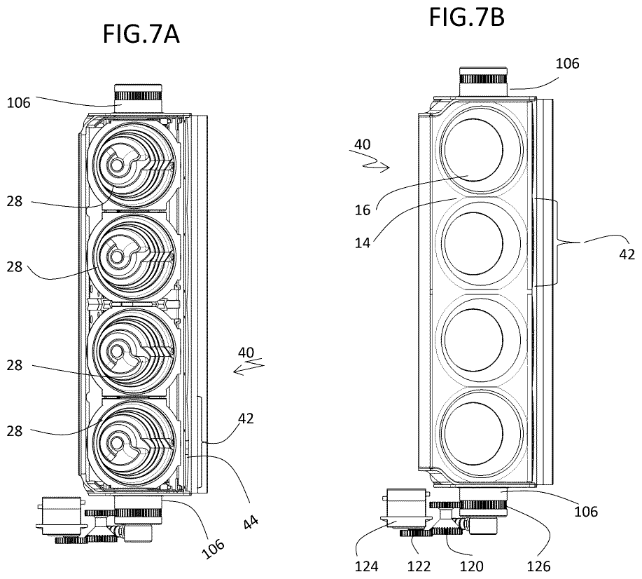

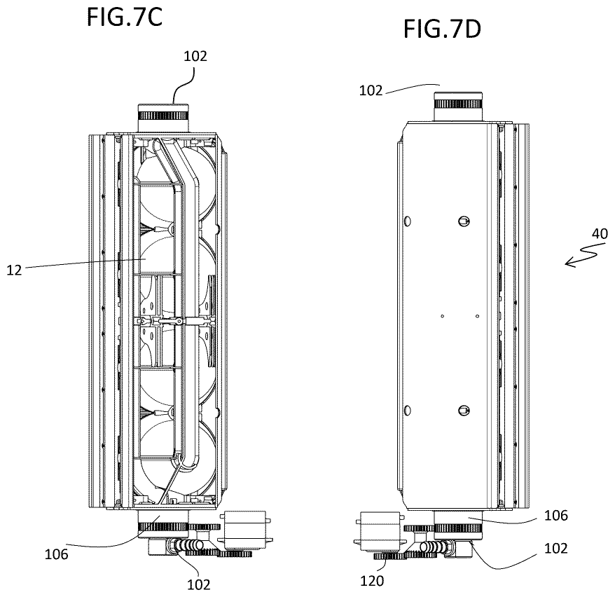

A fluid conduit 28, shown in FIG. 7A, is formed in the body 12 behind and proximate the forming member 14 and mold surface 16. In one embodiment, the conduit 28 has a fluid input 30 and a fluid output 32. The fluid conduit 28 spirals about the axis 20 from the fluid input 30 to the fluid output 32. In one embodiment, shown in FIGS. 1 and 2B, the input 30 is located adjacent the rear of the forming member or cavity 18, with the flow of fluid spiraling outwardly around the axis 20 and mold surface toward the lip 24. It should be understood that the locations may be reversed (i.e., with the fluid inlet located adjacent the lip 24, and the fluid output 32 located adjacent the rear of the forming member or cavity 18).

In a preferred embodiment, as best seen in FIGS. 22-24, the conduits 28 for each of the forming molds 10 are fluidically connected in parallel. That is, an overall fluid supply, or input 34, is in fluid communication with each of the fluid inputs 30 of the conduits 28, while an overall fluid outlet 36 is in fluid communication with each of the fluid outputs 32 of the conduits 28. In this way, a single fluid source may supply the entire mold assembly 40. While four molds 10 are shown in the mold assembly of FIGS. 3, 4, 5, etc. it should be understood that a single mold, two molds, or more molds may define the assembly.

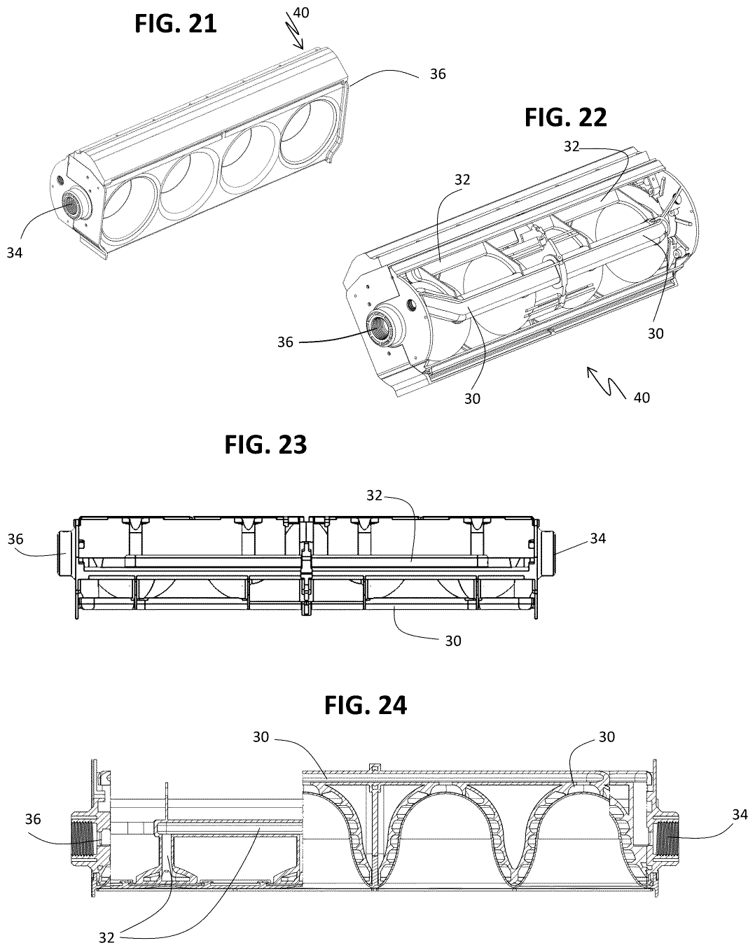

In an alternative embodiment, the conduits 28 for each of the forming molds 10 are fluidically connected in series. That is, the fluid output 32 of one conduit 28 may be connected to the fluid input 30 of a conduit 28 of an adjacent ice forming mold, with a plurality of molds being aligned and forming a mold assembly 40, comparable to as shown in FIGS. 3 and 21-24. An overall fluid supply, or input 34, may communicate with the first ice forming mold in the assembly, while an overall fluid outlet 36 may communicate with the last ice forming mold in the assembly. Again, in this way, a single fluid source may supply the entire mold assembly 40.

As described herein, the conduits 28 may carry either a cooling fluid (i.e., for purposes of cooling a surface of the mold(s) to promote ice formation within the mold(s)) or an ice separation or defrosting fluid (i.e., for purposes of heating a surface of the mold(s) to promote separation of ice from the mold(s)), wherein the fluid(s) may be a gas or liquid. In a preferred embodiment, as described below, the cooling fluid and the separation fluid may be the same fluid (either cooled or heated), for example propylene glycol, or a potassium-based fluid. During a cooling operation, the cooling fluid may have a temperature below 0 degrees C., for example a temperature of −18 degrees C.

A water inlet 42 is positioned at an upper portion, e.g. top, of the mold body 12. The water inlet 42 is configured to continuously stream water over the mold surface, although in alternative embodiments, the water inlet 42 may be configured to periodically stream water over the mold surface (e.g., for a fixed period of time, and/or based on a fixed volume of water), for example, at fixed intervals The water inlet 42 may include a plurality of nozzles or outlets 44 arranged across an upper portion of the mold body 12 such that water exiting the nozzles 44 flows (preferably, uniformly) along the face of the mold body and/or into the mold cavity 18. In one embodiment, the nozzles 44 each include a groove or slot that extends along the face of the mold body 12 to the periphery or edge of the mold surface 16, as shown in FIG. 5, which ensures that the water is evenly distributed to the edge of the ice forming mold surface 16. Due to a generally or substantially vertical orientation of the face of the mold, which corresponds to the laterally extending axis, the water stream is pulled by gravity across the mold surface 16, as shown in FIG. 1, with any excess water flowing out the bottom of the cavity 18. In one embodiment, and put another way, an uppermost portion of the mouth of the cavity is always higher than a lowermost portion of the mouth of the cavity, such that the water stream flows downwardly across the mold surface 16. As noted above, the outwardly curved convex surface of the second portion 24 facilitates adhesion of the water flowing over the mold surface thereon, so that the water enters the depths of the cavity 18, without separating from the mold surface due to gravitational forces, causing it to fall below.

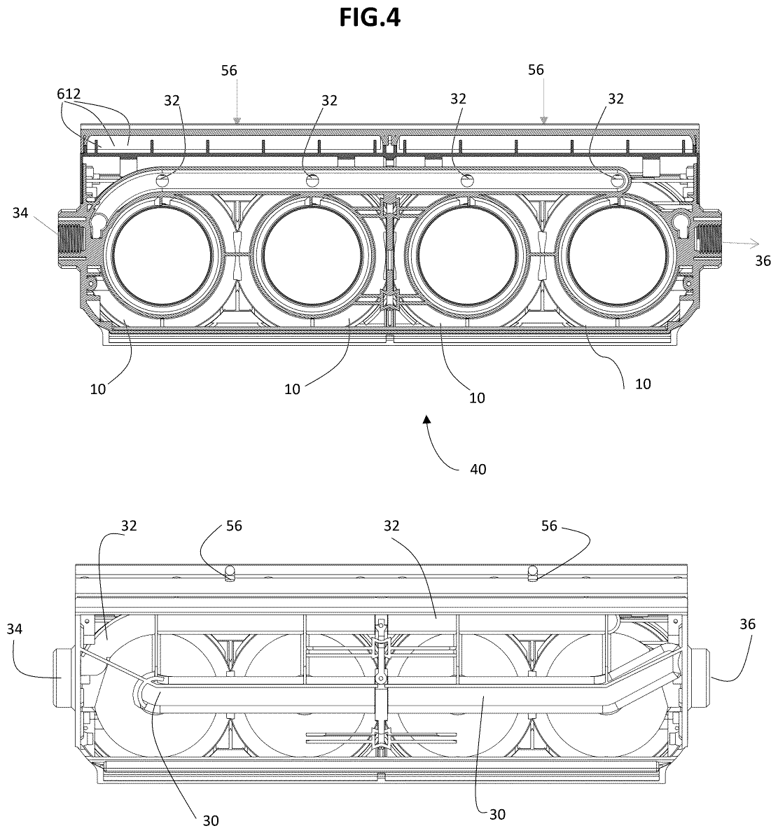

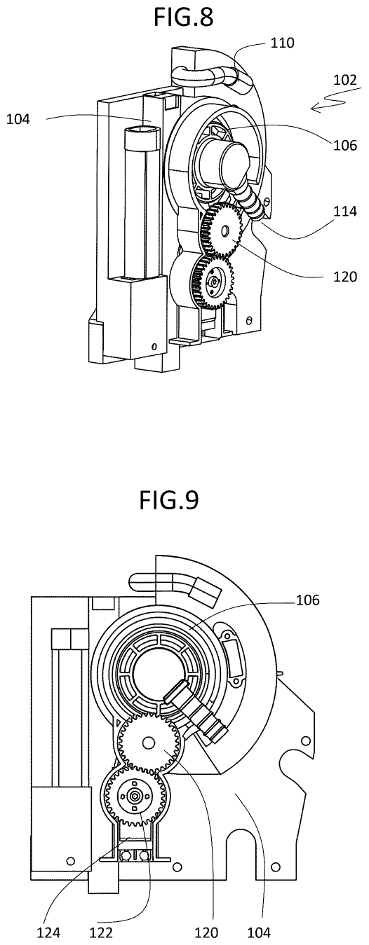

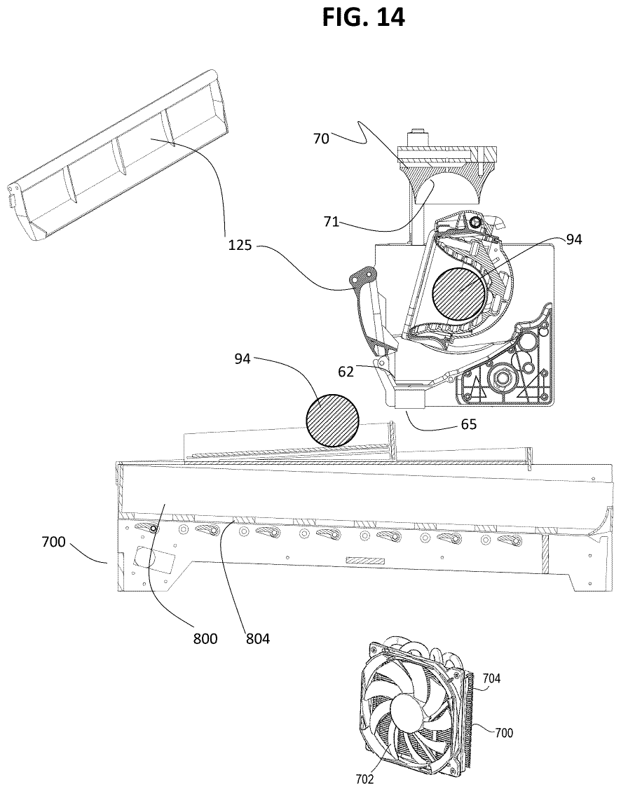

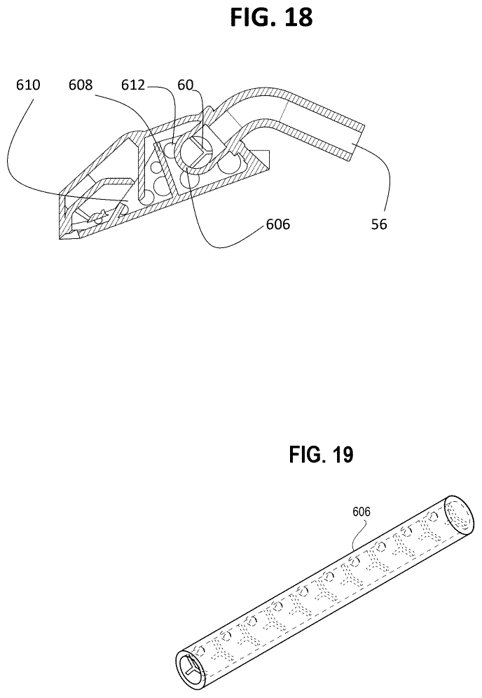

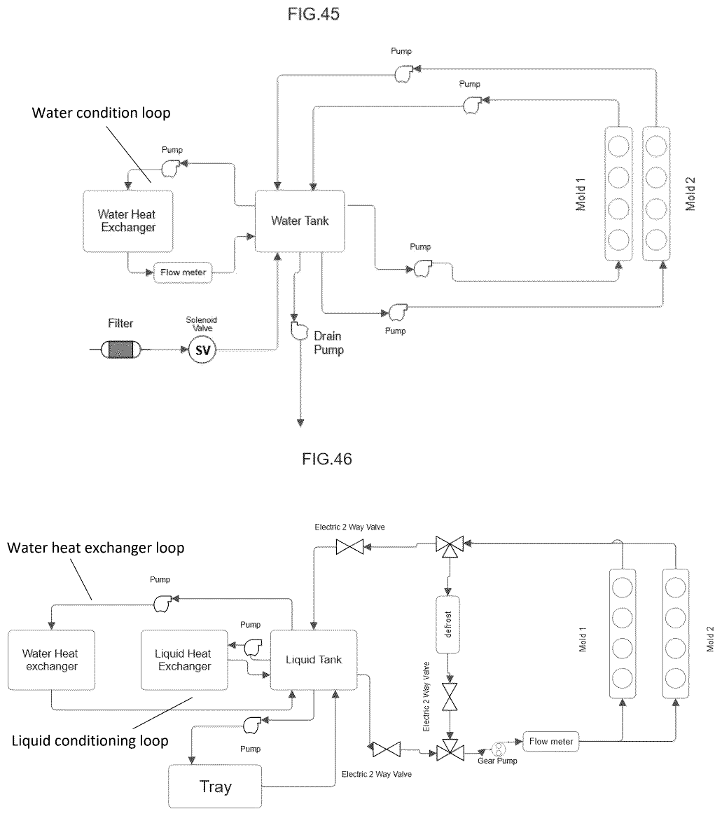

Referring to FIGS. 1-2, 8, 11, 18-19 25A-D and 45, a water supply system 50 includes at least one water tank 52 and a water heat exchanger 54 (see FIGS. 1 and 45). One water supply tank 52 supplies water, which passes through at least one heat exchanger 54, then returns to the water supply tank 52, whereinafter water in the water tank 52 is cooled, for example to 0 degrees C., or 0.4 degrees C. The cooling tank 52 supplies the cold water to the water inlet port 110, as seen in FIG. 8, then to the mold water inlet 56 (via flexible tubing, not shown), as shown in FIG. 4 and FIG. 18. Water entering the mold water inlet 56 is then conveyed into at least one water collection reservoir 606 in the form of a tubular conduit, as seen in FIGS. 18-19, which includes a plurality of water pressure breakers 60, which control the water pressure being supplied downstream to the nozzles 44. Water passing through the nozzles is then streamed over the mold surface 16 for purposes of ice formation. Any excess water not forming an ice piece, or any water produced by melting the ice piece, as further explained below, is collected in a water reservoir, such as a tray 62, as seen in FIGS. 1 and 14. Water collected in the tray 62 is then conveyed back to the water supply tank 52, as seen in FIG. 45.

As explained herein, with reference to the Second Mold Portion or Assembly, and FIGS. 18-19 and 25A-D, a water conditioning system captures small bubbles and facilitates a gentle and steady/continuous water flow. During the water streaming process, the temperature of the water stream is regulated to be at or near a predetermined temperature of 0 degrees C. This temperature control helps promote the formation of clear ice by minimizing impurities and ensuring consistent freezing conditions.

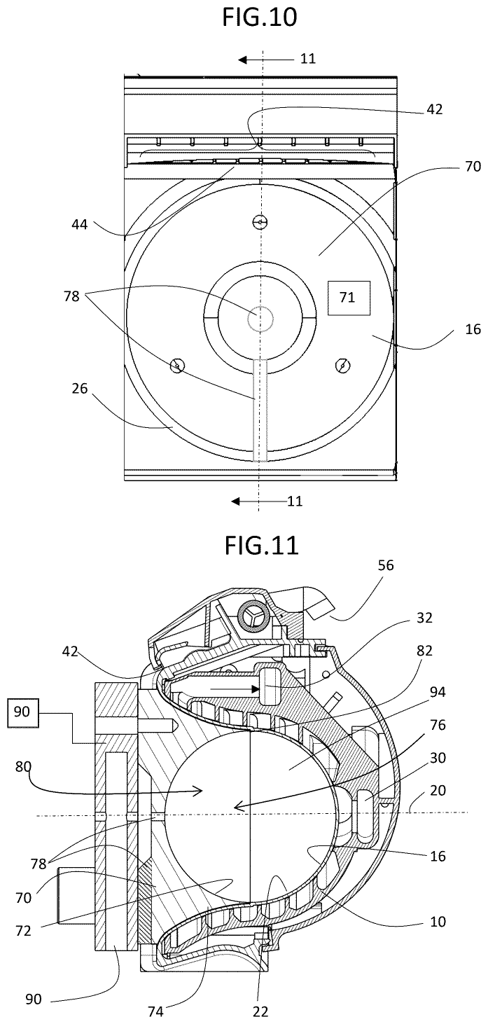

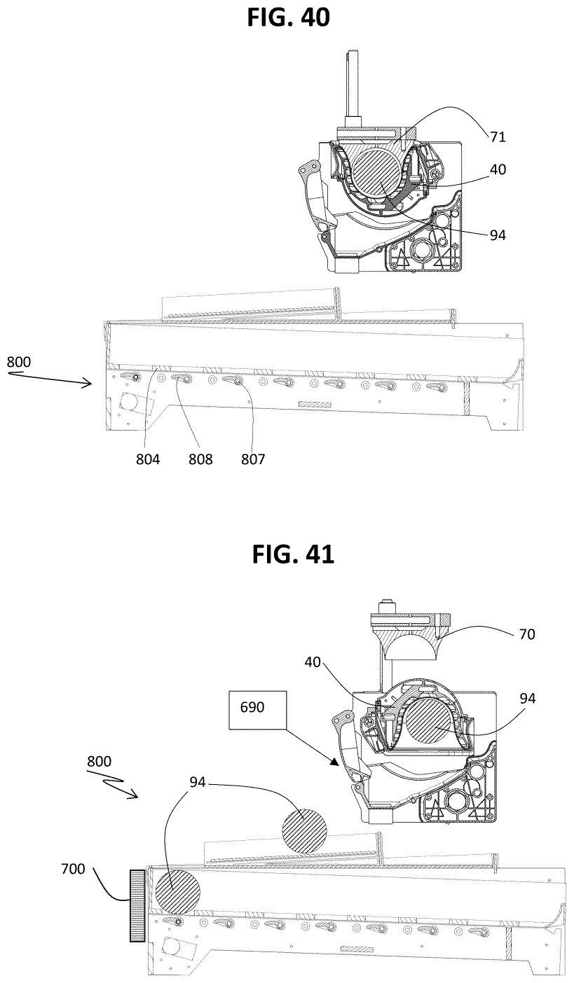

Referring to FIGS. 10-11, 27D, and 40, a heatable ice shaping mold 70, which may be made of metal, is configured with a second mold surface 72 defining a second cavity 76. In some embodiments, the ice shaping mold 70 is formed of aluminum, or a nickel plated aluminum. The term “heatable” refers to the ice shaping mold being maintained at ambient temperature, or greater than 0 degrees C., for example 40 degrees C. One or both of the ice shaping mold 70 and the ice forming mold 10 are moveable relative to each other from an ice forming position, wherein the shaping mold 70 is spaced apart from the ice forming mold 10, and a shaping position (see FIGS. 11 and 40), wherein the shaping mold 70 and the ice forming mold 10 are abutted such that the second cavity 76 of the shaping mold 70 and the first cavity 18 of the ice forming mold 10 define an ice piece shape 80. For example, the shaping mold 70 may move toward and away from the forming mold 10 via a linear motor or servo motor (with a power screw and gear system). In one embodiment, the ice shaping mold 70, and the mold surface thereof 72, has a concave surface. In one embodiment, the mold surface 72 defines a hemispherical shape, or other shapes defined by a curve rotated 360 degrees about the axis 20. It should be understood that other shapes, including polygonal shapes, may also be formed by of define the ice shaping mold. Likewise, it should be understood that the ice forming mold may have a first shape, and the ice shaping mold may have a different second shape, such that a variety of shapes, or ice pieces with mixed shapes, may be formed. The ice shaping mold 70 may be heated, and preferably includes a peripheral, circular knife edge 82, defined at the junction or apex of the inner mold surface 72, and an outer concave surface 74 that is shaped to mate with the convex surface 24 of the second portion of the ice forming mold 10. The circular knife edge quickly penetrates the formed ice piece (especially when heated), with the mold surface 72 melting the formed ice piece, during the shaping operation until the ice shaping mold 70 is abutted with the ice forming mold 10. The ice shaping mold 70, which is preferably metal, may be heated by an electrical heating system 90, illustrated generally in FIG. 11. For example, the electrical heating system 70 may comprise one or more electrically resistive wires or coils housed in the ice shaping mold, such that when energized, the wires or coils generate heat, thereby heating the ice shaping mold 70. In alternative embodiments, the electrical heating system may comprise the flow of a heat fluid through one or more conduits in the ice shaping mold, wherein the fluid is heated at a remote location and then conveyed to the ice shaping mold 70. In one embodiment, the ice shaping mold is heated to approximately 80-90 degrees C. before being pressed against the formed ice piece. In a preferred embodiment, the ice shaping mold 70 moves, for example, by linear actuator via signals from a controller, with the ice-melting process continuing until the ice piece reaches a finished shape. In alternative embodiments, the ice shaping mold 70 may move under its own weight, to press against the formed ice piece

As seen in FIGS. 10-11, an aperture 78 is formed in the ice shaping mold 70, so as to allow melted ice to be displaced through the shaping mold 70 without affecting shaping of the ice inside the cavity of the ice shaping mold 70. The aperture 78 may comprise an opening and/or a channel or slit to convey the melted ice to the tray 62 positioned therebelow.

As disclosed above, the fluid conduit 28 carries a cooling fluid during the ice forming process, but also carries an ice separation fluid during an ice separation process, wherein the mold surface 16 is heated, for example to ambient temperature, which causes the finished ice piece 94 to separate from the mold surface 16. The cooling fluid may be a food grade liquid, for example and without limitation a food grade propylene glycol mixed with water, for example 50% water. Alternatively, the cooling fluid may be a potassium-based liquid.

As noted above, the cooling fluid and the separation fluid may be one in the same fluids, conditioned to different temperatures. The cooling fluid and the separation fluid may be stored in the same tank or in different tanks. The cooling and separation fluids may be supplied to the conduit 28 using one-way and two-way valves, along with a pump. The ice separation fluid raises the temperature of the first mold surface 16 above 0 degrees C. The cooling fluid may be regulated by an electronic control circuit or controller to maintain the constant temperature required for the ice forming mold, or mold assembly. One or more pumps may direct the fluid liquid to the ice forming mold 10 at a specific flow rate, ensuring uniform cooling across the mold surface 16 throughout the operation. Throughout the clear ice creation process, the temperature of the ice forming mold 10, and in particular the mold surface 16 thereof, is controlled, for example with a temperature sensor located at the output of the cooling liquid tank. This temperature control aids in the slow and gradual freezing of the water, allowing impurities to settle and promoting the formation of transparent, clear ice pieces.

Referring to FIGS. 5-9, the ice forming mold 10, or mold assembly 40 configured with a plurality of molds 10, is rotatable about, or may be rotated about a horizontal axis 100 by a mold positioning system 102. The system includes a pair of bases 104 and a pair of plates 106 secured to opposite ends of the mold body 12, or assembly 40. The plates are rotatably mounted to the base 104 about the horizontal axis 100. One base includes a fluid input port 114 and a water input port 110, while the other base includes a fluid output port 108, with the bases in fluid communication with the mold 10 and/or assembly 40 for both the water supply and cooling/separation fluid supply. To the extent water entering the water input port 110 is not formed into ice, it may be output to the tray 62 and/out water outlet 65, as seen in FIG. 14. Optionally, as seen in FIG. 14, a splash guard 125 pivotally mounted relative to the ice forming mold may be provided, so as to collect excess water splashed from the mold, and directed into the tray 62 positioned therebelow. As ice pieces are discharged from the mold, the splash guard 125 may pivot out of the way, so as to permit the ice pieces to fall therebelow. A transmission 120, including a plurality of gears 122, is disposed between a servo motor 124 coupled to the base and a driven gear 126 coupled to the plate 106. The servo motor 124 drives the transmission 120 and driven gear 126 so as to rotate the plates 106, mold 10, and mold assembly 40.

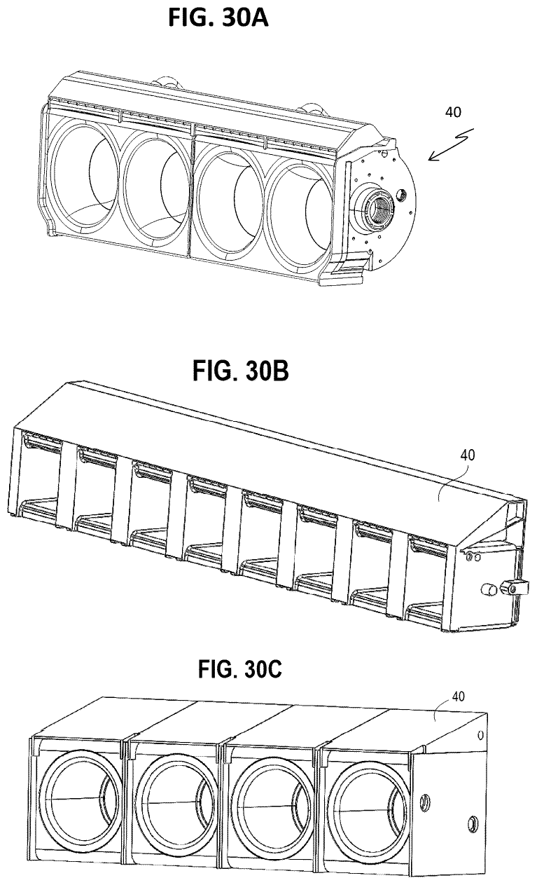

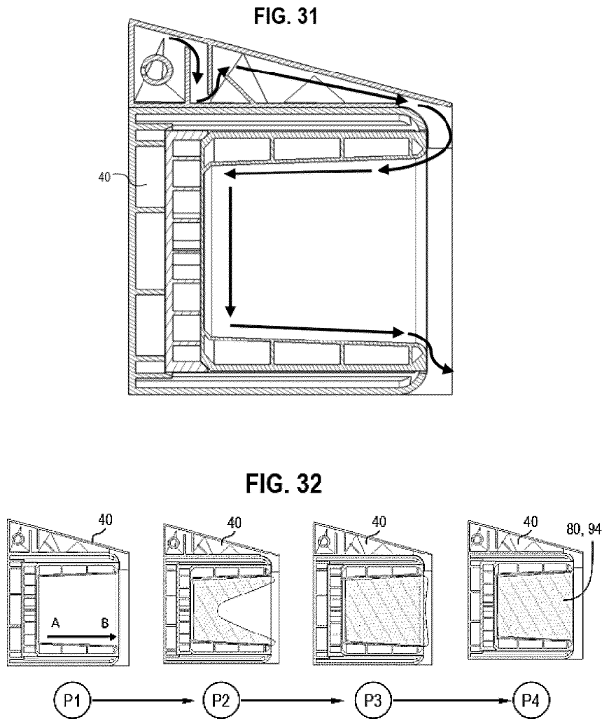

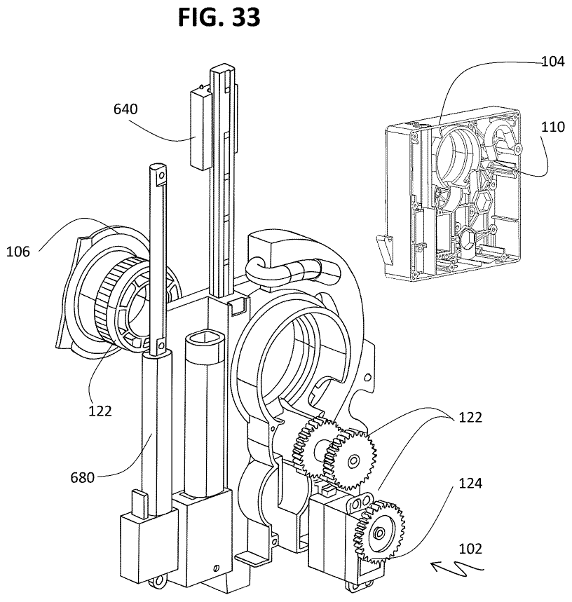

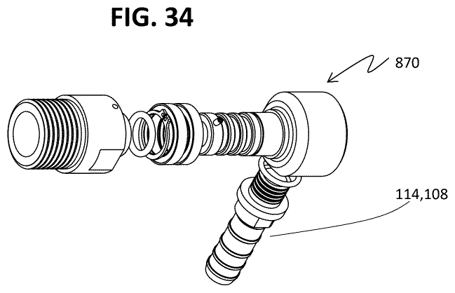

For example, as illustrated in FIG. 6, the plate 106 and mold 10, or mold assembly 40, may be oriented such that the axis 20 of the cavity 18 forms an angle α relative to a horizontal plane (P), or the face of the mold forms an angle α relative to a vertical plane. The axis 20 may also be orthogonal to the mold rotation axis 100. In one embodiment, α is between 5 and 50 degrees, and may be preferably 15 degrees, when the ice forming mold is in the ice forming position. The amount of rotation depends on the kind of mold; for example, the rotation may be 15 degrees for sphere mold ice, 45 degrees for cubic ice mold. and 40 degrees for the cylinder mold, with exemplary molds being shown in FIGS. 30A-C.

The mold positioning system may also rotate the mold 10, or mold assembly 40, such that the axis 20 extends downwardly, between −45 degrees and −135 degrees when the ice forming mold is moved to an ice removal position. In one embodiment, the rotation mechanism rotates the mold under the following exemplary conditions: 1: the ice forming mold 10 or mold assembly 40 is rotated to be located at 15-45 degrees (15 degrees for sphere mold, 45 degrees for cubic mold and 40 degrees for cylinder mold); 2: At various intervals (for example, every minute, every 5 minutes, every 10 minutes), the mold is rotated to −90 degrees for 5 seconds and then comes back to 15 degrees; 3: the mold is rotated to zero degrees so that the ice-shaping mold can form the ice into the final shape; 4: the mold is rotated to −90 degrees so that the defrost system can defrost ice from mold; 5: the mold is rotated to 90 and −90 degrees during the cleaning process. Through this “waving” motion, rotation of the molds removes any frozen water from the nozzles, redistributes the water across the entire surface of the nozzles 44, so that the water covers the surface of the mold evenly. Rotation of the molds also redistributes water residing in the mold cavities, and removes excess water accumulated in the mold cavity by dumping such excess water in the tray 62 below.

A control circuit or controller initially positions the mold 10 at the various orientations, e.g., 15 degree angle (α), with the servo motor 124 or motor system, and the transmission, or gear box. The flow of water into the mold cavity 18 and subsequently activation of the flow of cooling fluid within the mold conduit 28 is then initiated by the control circuit. The liquid is directed (via flexible tubing, not shown) to the set of molds via a rotary coupling 870. As shown in FIG. 34, a rotary coupling 870 interfaces with the mold unit 40, such that a cooling/separation fluid supply from a fluid input port 114 is maintained as the mold unit is rotated.

In operation, one method of making ice pieces includes orienting an ice forming mold 10 in the ice forming position, for example as shown in FIG. 6. In this position, the mold surface 16 defines a cavity 18 opening laterally outwardly. The method further includes circulating the cooling fluid through the conduit 28 and thereby cooling the mold surface 16 with the cooling fluid. For example, in one embodiment, the cooling fluid is brought to a temperature of approximately minus 20 degrees C., and concurrently, the water temperature reaches about 0.4 degrees. At this point, the ice maker initiates operations, including streaming the cold water from an upper portion of the ice forming mold 10 over the first mold surface 16 and thereby progressively forming a formed ice piece on the mold surface 16 of the ice forming mold 10, or plurality of ice forming molds 10 in the assembly 40. Incremental layer-by-layer formation of ice on the mold surfaces 16 is implemented through the streaming of the water over the mold surfaces 16. Depending on the shape of the mold, a formed ice piece may have at least a portion thereof with a hemispherical shape defined by the concave surface portion 22 of the mold. Water and cold liquid flow into the ice forming mold 10 until a clear formed ice piece is fully formed. In one embodiment, and before shaping, the ice piece may have a bell shape. After a clear formed ice piece is fully formed, the flow of the cooling fluid is stopped. After a predetermined period of time, for example 4 minutes, the water flow over the ice forming molds 10 is stopped and the ice melting system is activated. This predetermined time assists in stabilizing the ice crystal of the formed ice piece.

After the cavity is filled with ice, the method further includes pressing the heated ice shaping mold 70 against the formed ice piece and thereby melting the formed ice piece to define a finished ice piece. The ice shaping mold 70 may have a complimentary (e.g., hemispherical) cavity 76 shape or different shape than the ice forming mold 10. After the finished ice piece is formed, the method includes moving the heated shaping mold 70 away from the finished ice piece and heating the ice forming mold 10, for example by circulating ice separating fluid through the conduit 28. As noted above, the ice separating fluid may be the same fluid as the cooling fluid, only heated to an increased temperature. As the ice separation system is activated, for example, an ice separation fluid at ambient or a heated temperature may replace the cooling fluid in the mold conduit 28. As the ice separation fluid flows through the conduit 28, the fluid heats the mold surface 16, of the ice forming mold 10. Through surface melting, the finished ice piece is separated from the ice forming mold 10 by the weight of the finished ice piece 94 and enters the sorting system, where it is sorted. Alternatively, the mold 10, and the mold surface 16 in particular, may be heated electrically or with warm air.

The method may further include rotating the ice forming mold 10 and releasing the finished ice piece 94 from the ice forming mold into a storage container, such as a tray. Specifically, once the ice piece achieves a finished shape, the ice melting system is set to default position and the rotary mechanism rotates the ice molds 180 degrees to initiate the separation of the finished ice piece 94 from the ice forming mold 10.

The ice separation system may incorporate a tank for the ice separation fluid (which may be the same tank containing the cooling liquid) with one-way valves and/or two-way valves, along with a pump. After separation, the finished ice pieces 94 are released from the mold onto tray 62. Then the servo motor rotates the mold to take it to the default position and in the process nudges the formed ice piece to drop onto ramp 805 and subsequently to tray 804. These trays may be designed to allow smaller or incomplete ice to pass through to an ice melting space. The finished ice pieces may be stored on the trays and/or in a holding chamber, which maintains the ice pieces at a temperature below 0 degrees C., for example at minus 4 degrees. Once the clear finished ice pieces 94 are produced, proper temperature control during storage preserves the quality and shape of the finished ice pieces. The clear finished ice pieces 94 are stored in conditions where the temperature remains consistently below freezing, typically within an optimal temperature range. This controlled storage temperature ensures the integrity and clarity of the clear ice are maintained until it is ready for use.

The total process of producing the clear finished ice pieces 94 is controlled by an electronic controller, e.g., PCB, which control the liquid and water temperatures, ice production timings, pumps, motors, servomotors, and other components. Additionally, it regulates the ice-melting process for final shaping. The controller orchestrates all the facets of the clear ice piece production based on a predefined algorithm(s), logic (fuzzy or otherwise), firmware, and/or software.

In one embodiment, the ice-making process is managed by a control system that includes sensors for ice and water levels, temperature controls, error reporting, and a timer to regulate the freezing and harvesting cycles. The production of clear ice involves an electronic control board that manages various aspects of the process. This includes regulating the temperature of the liquid and water, controlling the timing of ice production, managing pumps, motors, and servomotors, and overseeing the ice-melting process to give the ice its final shape. To achieve this, the board uses a predefined algorithm that controls every aspect of clear ice production. An exemplary algorithm is as follows:

### Start System

Display “STARTING”
Check all liquid tank sensors. (Water & Liquid Tank)
If each sensor is negative, then displays an error as below
If main water tank is empty display “Fill Main Water Tank”
If cool liquid/warm liquid tank is empty display “Fill Liquid Tank”
Turn on the compressor.
Cool cooling liquid in supply tank to −21±3° C.
Cool water in water tank to 0.5±0.3° C.

### Start Ice-Making Procedure

The ice mold 10 or assembly 40 will be adjusted at a 15-degree angle (the ice-forming position).

Convey cooling liquid to conduits 28 to cool molds.

Convey water to nozzles 44.

After 60 seconds, the servo motor turns on and rotates the mold upward 70 degrees (from the original 15 degree angle) to 85 degrees. The servo motor pauses rotation for two seconds, then reverses rotation back to the ice forming position (i.e., the original 15 degree angle). This process is repeated every 60 seconds for 40 minutes.

From 40 minutes to 70 minutes, every three minutes, the servo motor turns on and rotates the mold upward 70 degrees, pauses for two seconds, then reverses rotation back to the ice forming position.

At 80 minutes, the compressor is cycled off to begin warming of the cooling liquid (which may be used as the separation liquid).

From 70 minutes to 90 minutes, every five minutes, the servo motor turns on and rotates the mold upward 70 degrees, pauses for two seconds, then reverses rotation back to the ice forming position.

Water and cold liquid flow into the molds continues until clear ice forms completely.

The process is controlled by time (around 90 min).

After 90 minutes, cooling liquid flow may be stopped.

During the ice formation process, the flow of water and cooling liquid must be controlled by the system. Specially, the system inputs must be driven so that ice formation begins when the cooling liquid is at a predetermined temperature (e.g., −18° C.), where ice will begin to form directly on the mold surface 16. Then, as ice accumulates on the mold surface, and an ice barrier is formed between the mold surface and the outer surface of the ice, increased cooling capacity is required to continue ice formation on the outer surface of the ice. As such, the system operates to lower the temperature of the cooling liquid, so as to maintain ice production through the increasingly thicker layer of ice on the mold surface 16. When ice formation is complete, or near completion, the system may decrease cooling capacity of the cooling liquid.

Table 1 shows an exemplary comparison of time and temperature during the ice forming process.

TABLE 1
% Time v. Temperature

| Time % of Total Time | Temperature (Degrees Celsius) |
|---|---|
| 0 | −18 |
| 10 | −22 |
| 20 to 80 | −23 |
| 90 | −20 |
| 100 | −18 |

### Ice Shaping—Activation of Melting System

Start to heat ice shaping mold up to 90° C.

The water flow on the molds should be stopped.

The ice forming mold remains at the default position (i.e., 15 degrees).

Ice forming mold will be rotated 75 degrees upward (i.e., to 90 degrees).

Ice shaping mold is moved downward via linear actuators toward the ice forming mold or assembly.

The ice-melting/shaping process goes on until the ice reaches its final shape.

Sensors or switches may be utilized to sense the relative positions of the ice forming mold and the ice shaping mold to determine completion of the ice-melting/shaping process.

Once the ice achieves its final shape, the ice melting system (including the ice shaping mold, separated from the ice forming mold) is set to the default position.

### The Ice Release System (Defrost)

The ice molds are rotated downward 180 degrees (i.e. to −90 degrees).

The ice release system will be activated for 60 to 120 seconds, causing a heated separation fluid to flow through the conduits 28.

Ice that has been released will be directed into tray 62 and the ice sorting system.

During the process flow of water and liquid must be controlled by the system.

Design the system to ensure that all ice goes into trays after defrosting.

### Ice Production Unit for Ice Maker Machines

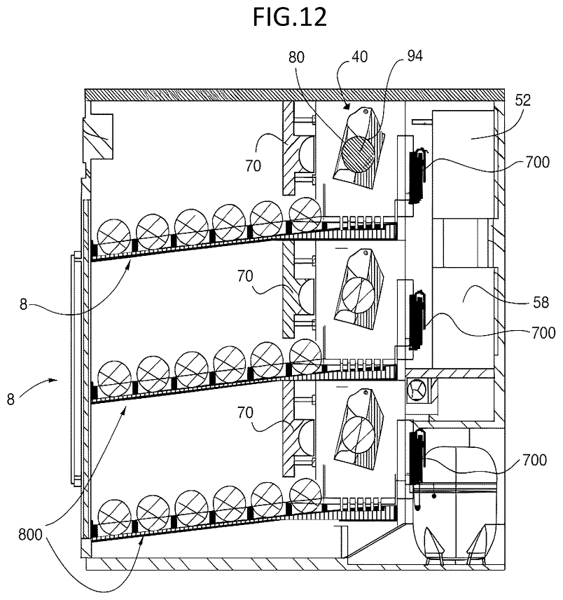

Referring to FIGS. 12-14, an ice maker 8 includes an ice creator unit, which as presented herein represents an innovative solution for generating clear ice within the ice makers 8, and including various components to optimize ice production processes.

This unit encompasses an ice forming mold 10, an ice shaping mold 70, rotation and movement mechanisms, a defrost system, a drying mechanism, and an ice storage system with a sorting mechanism, collectively enhancing ice production efficiency and quality.

Within the ice creator unit, one or more molds 10, 70 are accommodated, offering flexibility in ice production configurations. These molds can function independently or as part of a multi-mold system integrated within the unit, facilitating simultaneous ice production in multiple forms.

In a multi-mold system, the circulation of cold liquid can occur in series or parallel configurations between molds, allowing for efficient cooling and ice formation processes.

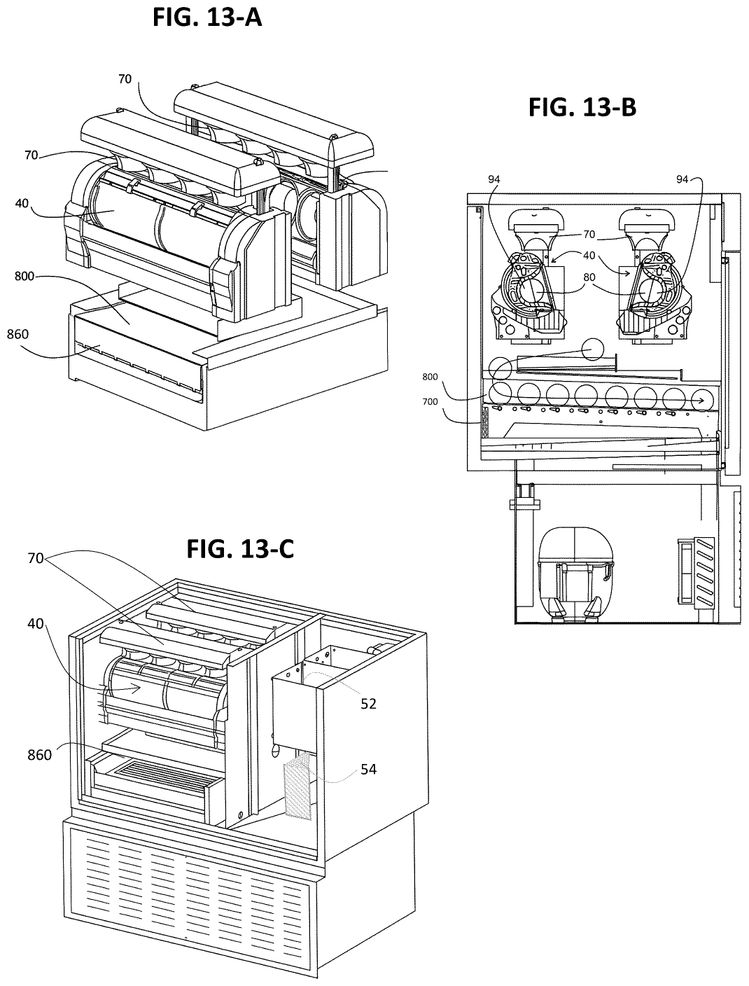

The ice maker machine 8 can incorporate one or more ice creator units, depending on the desired ice production capacity and configuration. These units can operate independently or in conjunction to meet diverse ice production requirements. The units may be arranged vertically, as shown in FIG. 12, or horizontally as shown in FIGS. 13A-C, or both, within the same ice maker machine.

Overall, the ice creator unit provides a versatile and efficient solution for clear ice production within ice maker machines, enhancing the capabilities and functionality of ice production systems.

### Ice Forming System

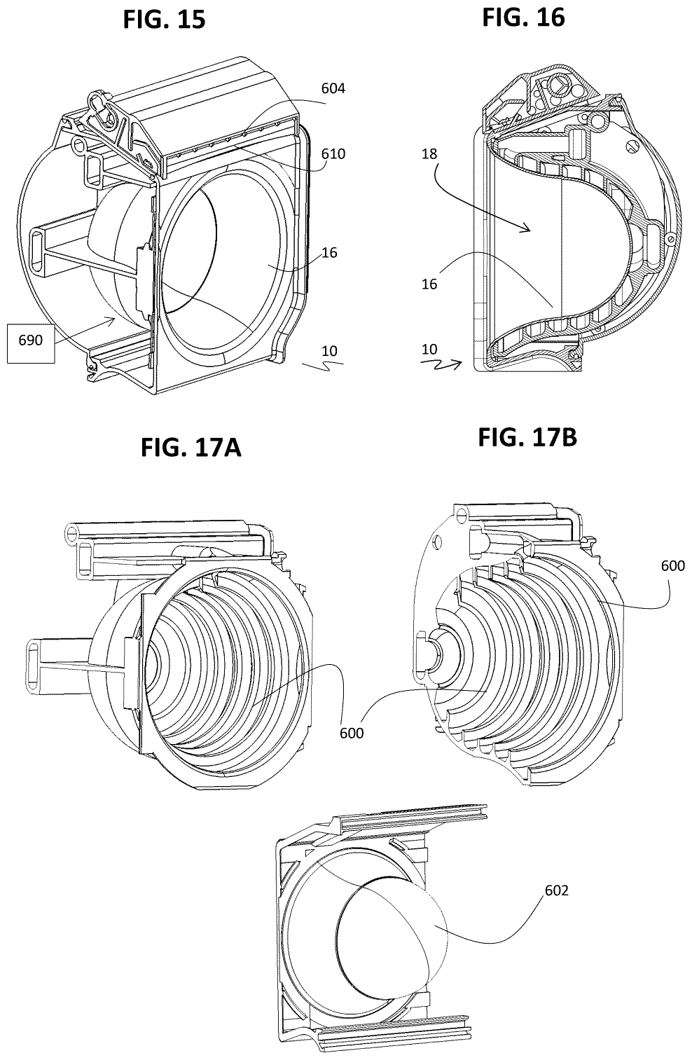

Referring to FIGS. 15-24, the ice-forming system disclosed herein includes an ice mold 10, which may include multiple parts designed for efficient ice production and shaping. The device allows for the creation of ice in various shapes, providing versatility for different applications. The system includes an ice production part, or ice forming mold, and an ice shaping part, or shaping mold. The device is designed to produce ice in various shapes, such as spheres, cubes, cylinders, and others. The ice forming mold may include a first portion with an internal spiral for uniform cooling. This part is capable of producing ice in spherical, cubic, cylindrical, or other shapes, depending on its form.

A cooled liquid circulates inside the mold 10 through a spiral 600 that is placed, or positioned, around the part 602, cooling the surface evenly. A cooling system injects the cooling liquid into the mold cavity, maintaining controlled temperatures for proper ice formation. The second part 604 of the mold directs water uniformly over the mold surface 16 for ice formation, with a rotating mechanism adjusting angles of the combined mold components for optimal ice clarity.

### First Mold Portion or Assembly

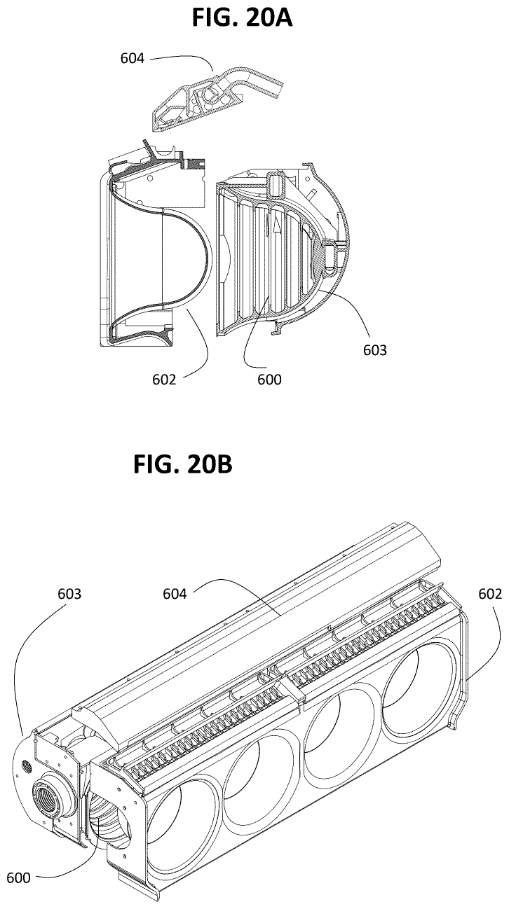

The first forming mold portion or assembly 602 and spiral 600 may be separately and releasably coupled, such that those portions may be attached and unattached as shown in FIG. 20. The mold portion or assembly 602 and spiral 600 may be separate from and supported by a housing body 603.

In the unattached, or separated configuration, the first portion of the mold features an internal spiral structure 600 that is placed around the surface 602, intended for uniform cooling of the ice mold. A cooling liquid may be circulated through the spiral, ensuring even cooling of the mold surface. The mold surface 16 of mold portion 602 facilitates heat transfer from the water flowing over the mold surface to the cooling liquid, smoothing the ice production process. The cooling system is responsible for injecting the cooling liquid into the mold cavity, ensuring sufficient cooling for ice formation. Temperature control of the mold surface is maintained throughout the process via a control circuit, or controller, following a predefined temperature diagram. The interior surface of the component 602 may be thoroughly polished and smooth to maximize the transparency of the formed ice. In one embodiment, a suitable metal material is copper with electroless nickel plating, with the surface being polished. In other embodiments, the mold material may be polished plastic, or a combination of metal and plastic, with suitable smoothing or conductive coating. One suitable coating is Teflon or nickel plating. A suitable plastic is food grade Nylon 12.

### Second Mold Portion or Assembly

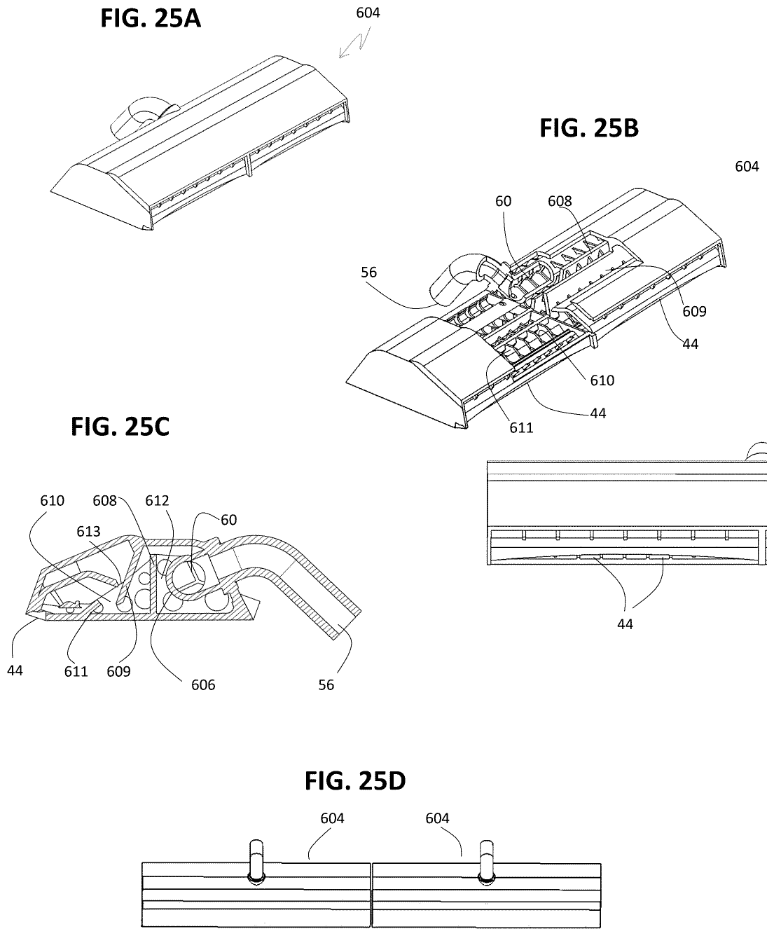

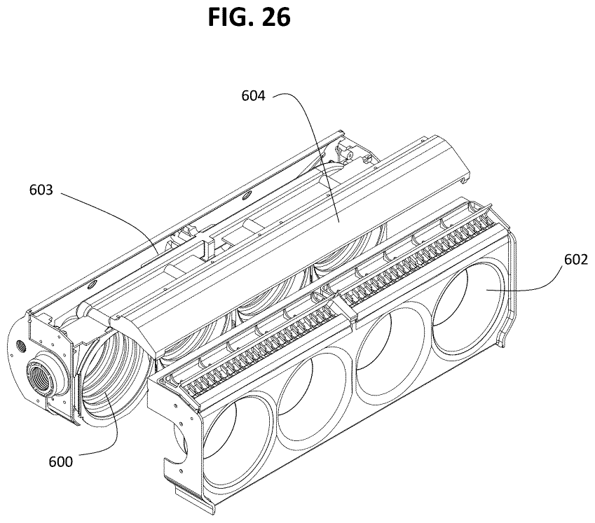

Turning to FIGS. 25A-D, the second mold portion or assembly 604 functions as a water condition system, which is responsible for directing water uniformly over the mold surface 16 of the ice forming mold for ice formation. The second mold portion or assembly 604 may include channels and reservoirs to guide the flow of water evenly across the mold surface. At least one portion of the mold cavity on the outer surface facilitates water flow, ensuring uniform coverage. This part includes at least one water collection reservoir 606, in the form of a tubular conduit which includes a plurality of water pressure breakers 60 and a plurality of holes or perforations to allow water to pass therethrough, while at the same time, ensuring uniform pressure distribution across the conditioning system 604. After exiting the reservoir 606 through the plurality of holes, the water enters one of a plurality of laterally extending channels 610. Within each channel 610 is positioned a volume-regulating wall 608, requiring the water level in each channel 610 to rise above the volume-regulating wall 608 in order to flow laterally outward toward nozzles 44. After flowing over the volume-regulating wall 608, the water must flow under a second volume-regulating wall 609, and over a third volume-regulating wall 611. The combination of the volume-regulating walls 608, 609, 611 effectively moderate the volumetric flow of water through each channel, so that a relatively uniform stream or flow out of each nozzle develops along the longitudinal length of the mold surface 16. Additionally, one or more vents 613 are associated with each channel 610, so as to permit evacuation of air or bubbles entrained in the water flowing therethrough. As water moves through these channels 610, the different sections of the walls are utilized to ensure the water within the channels becomes uniform and free of bubbles. Ultimately, the evenly distributed and film-like water flows out of the nozzles 44 and over the surface 16 of the forming mold.

### Rotating Mechanism for Mold Positioning During Ice Formation

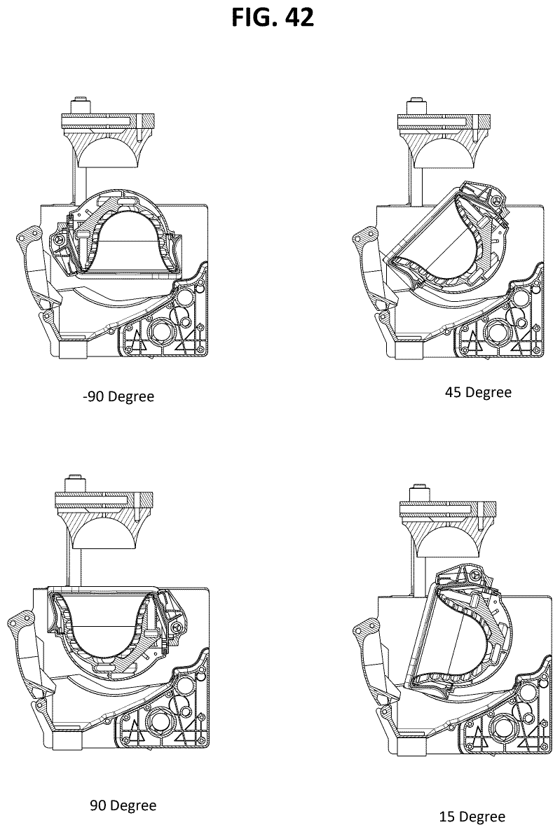

Referring to FIGS. 33, 34, and 40-42, a rotating mechanism, or mold positioning system 102 designed for precise mold positioning during the ice formation process is disclosed. Positioned on both sides of the first mold portion or assembly, this mechanism adjusts the angles of the mold to ensure optimal ice formation, enhancing transparency and quality. Controlled by a control circuit, or controller, the mechanism utilizes servo motors 124 or DC motors in conjunction with a transmission 120 and/or gears 122 to achieve the necessary precision in mold rotation. The system includes a rotating mechanism incorporated into a mold system for enhancing the ice formation process. A third mold portion, or plates 106, are positioned on both sides of the first mold portion to facilitate precise mold positioning during ice formation. The rotating mechanism enables adjustment of the mold angles, ensuring optimal ice formation according to the desired shape. This adjustment enhances transparency and quality in the resulting ice products. The mechanism is operable through servo motors or DC motors, offering flexibility in motor selection based on specific application requirements. Gears are utilized in conjunction with the motors to adjust the angular ratio, thereby achieving the necessary precision in mold rotation. Servo motors or DC motors facilitate the rotational movement of the mold, allowing it to be positioned in any desired orientation. Control of these motors is centralized through a control circuit, or controller, which coordinates the rotational adjustments of the mold during the ice formation process. The rotation mechanism 120 is located on base 104, as illustrated in FIG. 8.

In summary, the third mold portion represents an innovative solution for optimizing mold positioning during ice formation. By incorporating a rotating mechanism controlled by servo motors or DC motors, the system ensures precise adjustments to achieve desired ice shapes, thereby enhancing transparency and quality in the final ice products.

### Ice Forming Mold and Logo Placement Feature

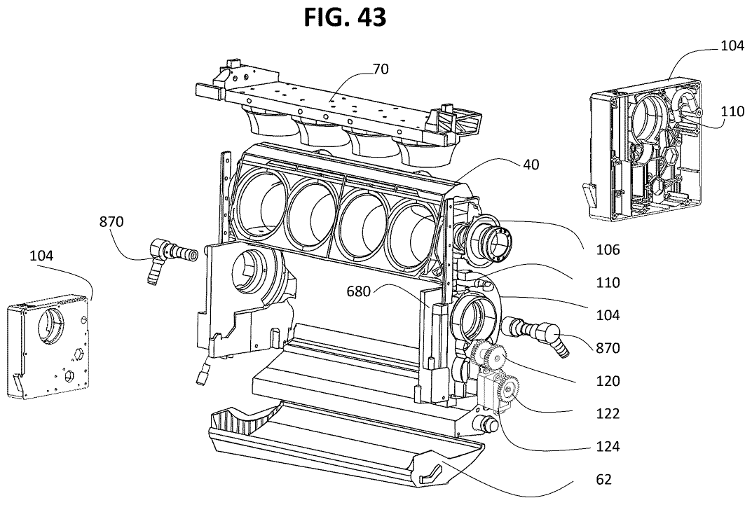

Referring to FIGS. 10-11, the system includes an ice shaping mold 70, designed for the final shaping process of ice products. This part comprises a heated metal plate and a forming section for shaping the ice into its desired final form. Additionally, a logo or emblem placement feature 71 (illustrated schematically in FIG. 10) may be integrated into this section of the mold to imprint desired logos onto the final ice products. The mold part 70 is tailored to the required shape of the ice and is equipped with a movement system, aided by sliders 640, to align with the first ice forming for creating the final ice shape. As seen in FIGS. 33 and 40-43, linear motion motors or actuators 680 enable the movement of the ice shaping mold 70, all controlled by a centralized control circuit, or controller.

The ice shaping mold 70 may include a heated metal plate, which maintains the optimal temperature required for shaping the ice. This plate works in conjunction with a forming section designed to give the ice its final desired shape. Moreover, a designated section 71 within this mold part is reserved for the placement of logos or emblems, ensuring that the desired branding elements are imprinted onto the final ice products. The configuration of this mold part is customized to match the required shape of the ice product being manufactured. Additionally, it is equipped with a movement system, featuring sliders that enable precise alignment with the first mold part during the shaping process. This alignment helps achieve the desired final form of the ice products.

Linear motion motors or actuators 680 are employed to facilitate the movement of the ice shaping mold within the mold system. These motors provide the necessary linear motion required for shaping the ice and positioning the logo or emblem. All movements are coordinated and controlled by a centralized control circuit, ensuring synchronized operation and precise execution of the shaping process. By integrating a heated metal plate, logo placement feature, and precise movement system, the mold enables the production of high-quality ice products with customizable branding elements.

### Ice Formation and Shaping Method

A method for forming ice from one side wall, or mold surface 16, to the opposite side of the mold is disclosed. The forming can take place vertically, as shown in FIG. 13C, or horizontally as shown in FIG. 14. This process continues until the ice completely covers and fills the mold cavity, at which point it undergoes final shaping through ice-forming operations.

The system introduces a method for the formation and shaping of ice within a mold, referred to as the “Ice Formation and Shaping Method.”

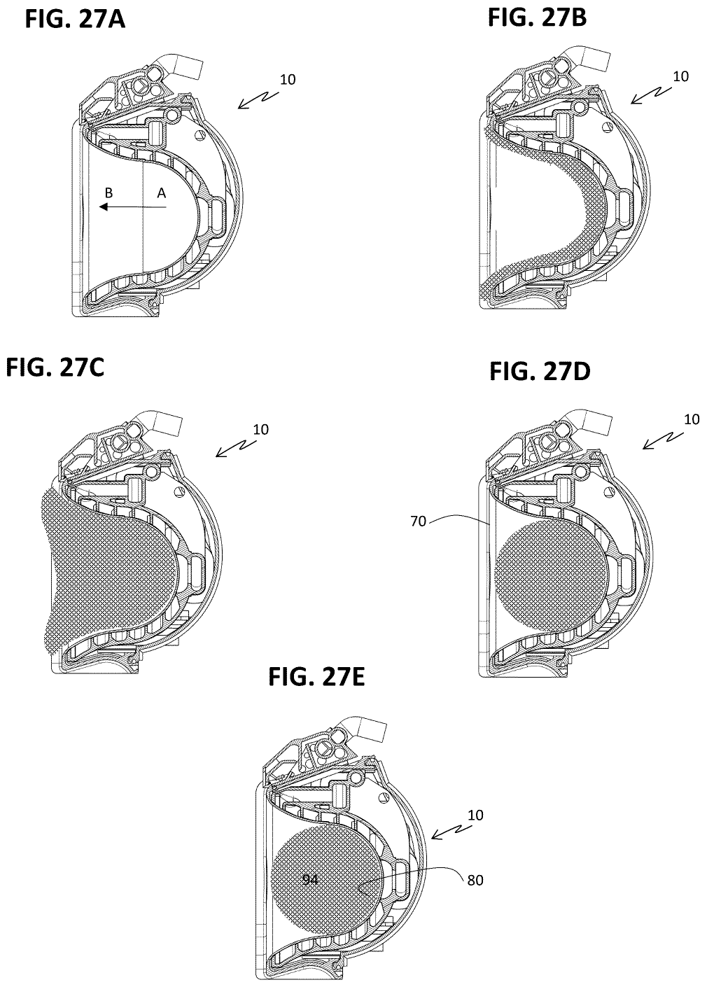

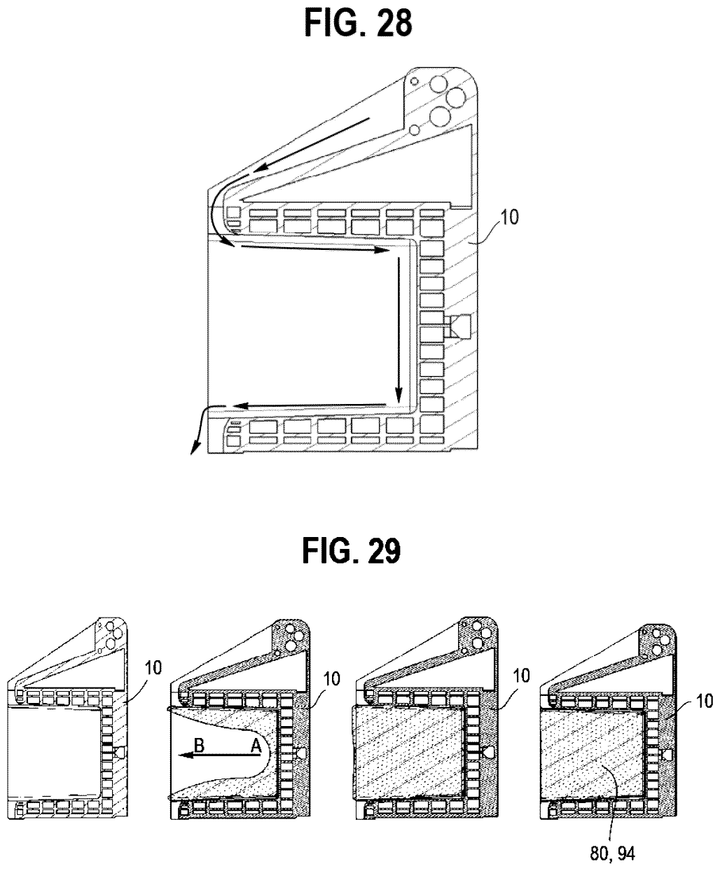

Once the forming mold 10 is completely covered by ice, as shown in FIGS. 27A-E, 29 and 32, the ice shaping operation commences to shape the ice into its final, desired form. This shaping process ensures the ice conforms precisely to the contours and specifications of the mold, resulting in a finished product with the desired shape and dimensions.

In summary, the Ice Formation and Shaping Method offers a systematic approach to efficiently form and shape ice within a mold, ensuring consistent and high-quality results.

The ice-forming system described herein offers an efficient and versatile solution for producing ice in various shapes. By incorporating uniform cooling mechanisms, controlled temperature regulation, and adjustable shaping features, the device enables consistent and high-quality ice production for a wide range of applications.

### Ice Mold Defrosting and Separation Mechanism

Referring to FIG. 41, the system includes an advanced system for efficiently detaching ice from molds after formation. Upon completion of ice formation, the defrost system initiates, employing rotation, tilting, and ambient or heated-temperature air or liquid flow to reduce the surface temperature of the ice, facilitating separation from the mold. Rotational movement of the molds aid in ice detachment, ensuring a smooth and effective process. This innovative system enhances the efficiency and reliability of ice production processes.

Upon the full formation of ice within the mold, the defrost system is activated to initiate the detachment process. Initially, the mold undergoes rotation and tilting facilitated by a rotation mechanism as shown in FIG. 41. This rotational motion prepares the ice for separation by loosening its grip on the mold surface. Subsequently, ambient or heated-temperature air or liquid flows inside the mold, effectively increasing the surface temperature of the ice attached to the mold to approximately zero degrees Celsius, or slightly above zero degrees Celsius. This air or liquid follows the same path as the cold liquid within the mold, contributing to the melting of surface ice and enabling the separation of ice from the mold.

In addition, servo motors 124 associated with the molds assist in aiding ice detachment. These motors generate rotational motions that further loosen the ice from the mold surface, ensuring a smooth and efficient separation process.

### Ice Drying Mechanism for Preventing Deformation and Sticking

The system discloses an innovative ice-drying system 700, shown in FIG. 14, designed to remove surface moisture from separated ice to prevent deformation and sticking during storage. For example, utilizing a combination of fans 702 and a refrigeration system 704 operating with a cold liquid, this system directs cool and dry air over the ice. The air circulates within the ice compartment, passing through a cooling radiator 704 facilitated by a fan 702, effectively removing surface moisture, and ensuring the preservation of ice quality during storage.

After the separation of ice from the forming mold 10, surface moisture needs to be eliminated to maintain ice quality. To address this, the ice drying system is employed, which directs cool and dry air over the ice with the assistance of fans and a refrigeration system operating with a cold liquid. The system utilizes fans 702 to facilitate the circulation of cool and dry air within the ice compartment. The air passes over the surface of the separated ice, effectively removing surface moisture and preventing ice deformation or sticking. Additionally, a refrigeration system operating with cold liquid aids in maintaining the temperature within the ice compartment, ensuring that the circulated air remains at an optimal temperature for ice preservation. Furthermore, the air inside the compartment is directed through a cooling radiator with the help of a fan. This cooling radiator effectively removes surface moisture from the ice through its circulation, enhancing the preservation of ice quality during storage. As an added method, cooling liquid in hoses inside the compartment may be provided, thereby further cooling the air inside the compartment. The fan then circulates the cooled air in the compartment, enhancing the preservation of ice quality during storage.

Ice Storage System with Sorting Mechanism

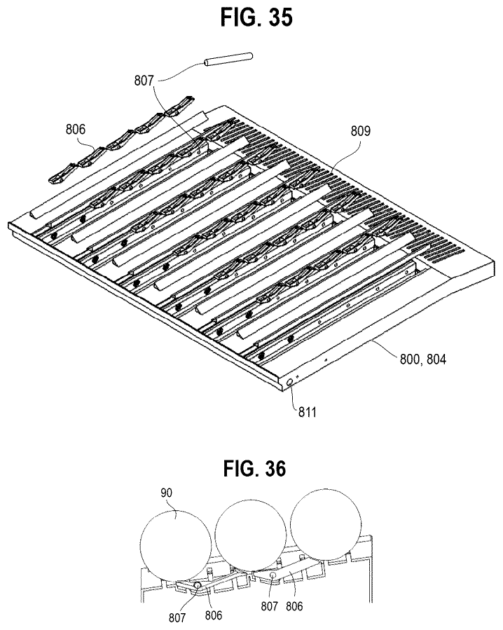

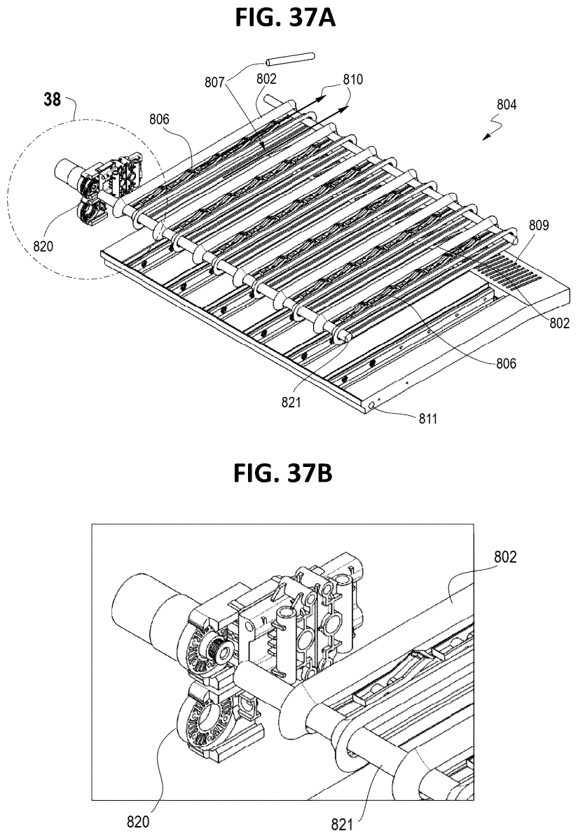

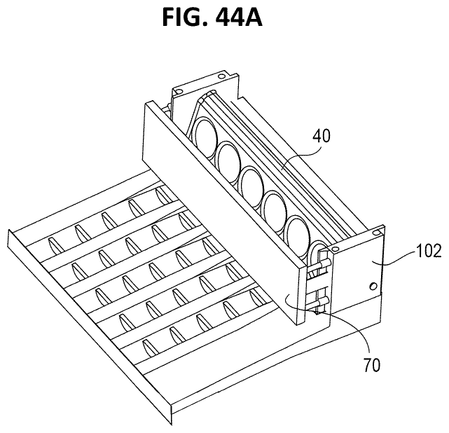

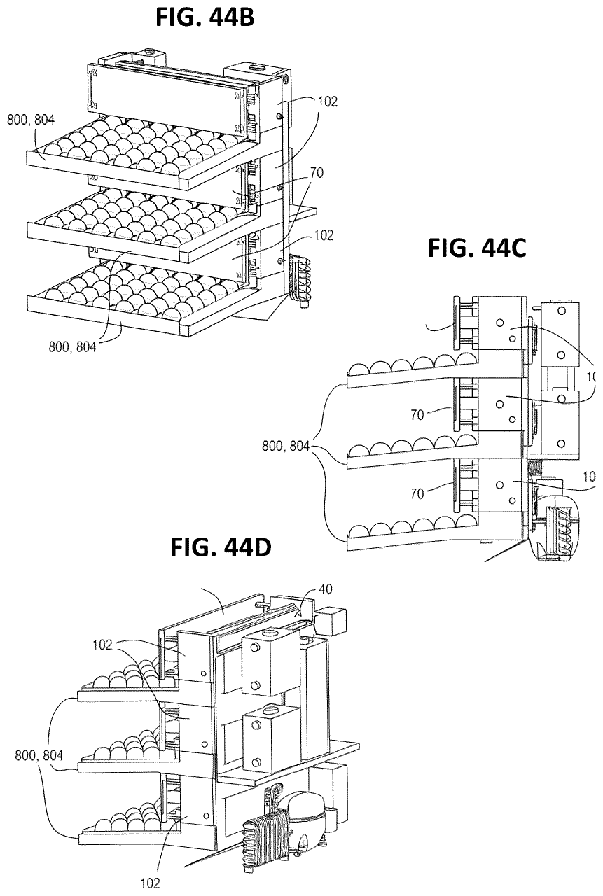

Referring to FIGS. 35-38C and 40-44D, the system discloses an automated ice storage system 800 equipped with a sorting mechanism for organizing ice within storage trays, which may be configured to receive ice pieces dropping from the molds positioned thereabove, onto tray 805. The mechanism may be activated either by utilizing ice weight or by employing motorized resin conveyor belts 802, levers 806, and/or cam shafts 808. The system includes trays 804 configured with resin or anti-freeze coatings to prevent ice adhesion. Ice is transferred onto these trays via a movable mold system, wherein ice pieces traverse paths within the trays due to gravity, motorized resin conveyor belts, levers 806, and/or cam shafts 808.

For example, in one embodiment, levers 806 strategically positioned along the paths guide the ice into designated locations, activating a sorting process based on weight distribution. This innovative system ensures a sorted arrangement of ice within the trays, facilitating efficient ice storage and retrieval. The levers 806 are pivotable about a pivot axis defined by pins 807. The tray includes a water gathering drain 809, and outlet 811. As an ice piece moves off a lever 806, the lever pivots and allows the next ice piece balanced on an end of the lever to move downwardly onto the lever, with a cascading effect, thereby lifting again the end of the lever to engage a next adjacent ice piece, as shown in FIG. 36.

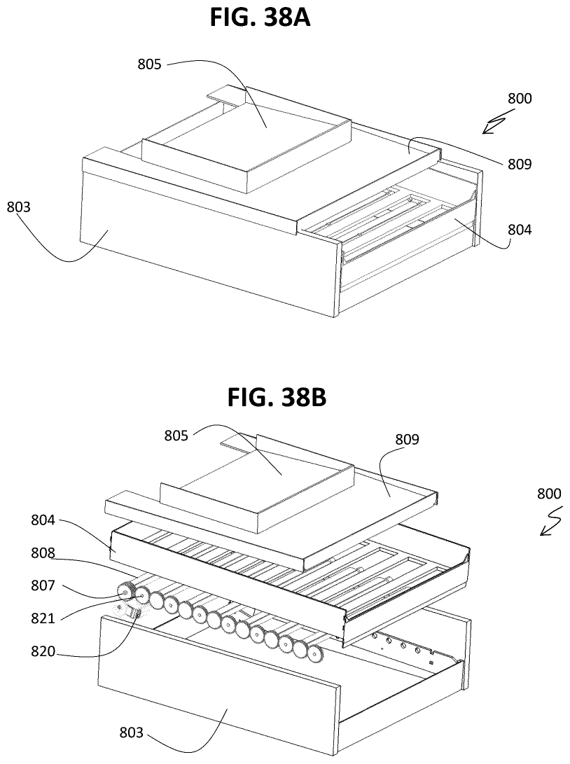

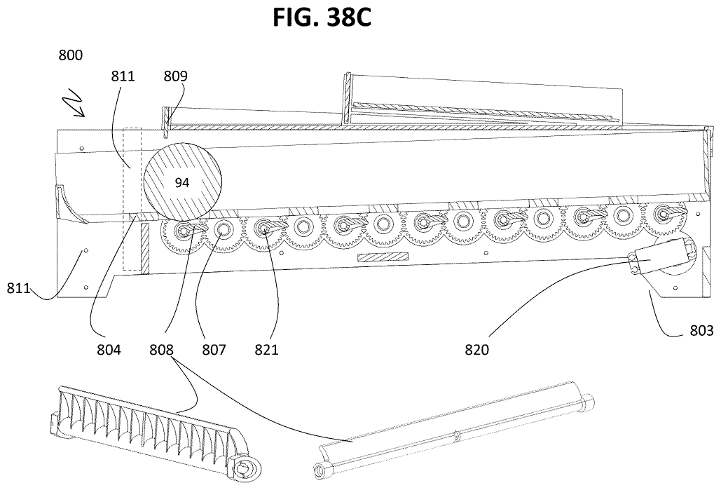

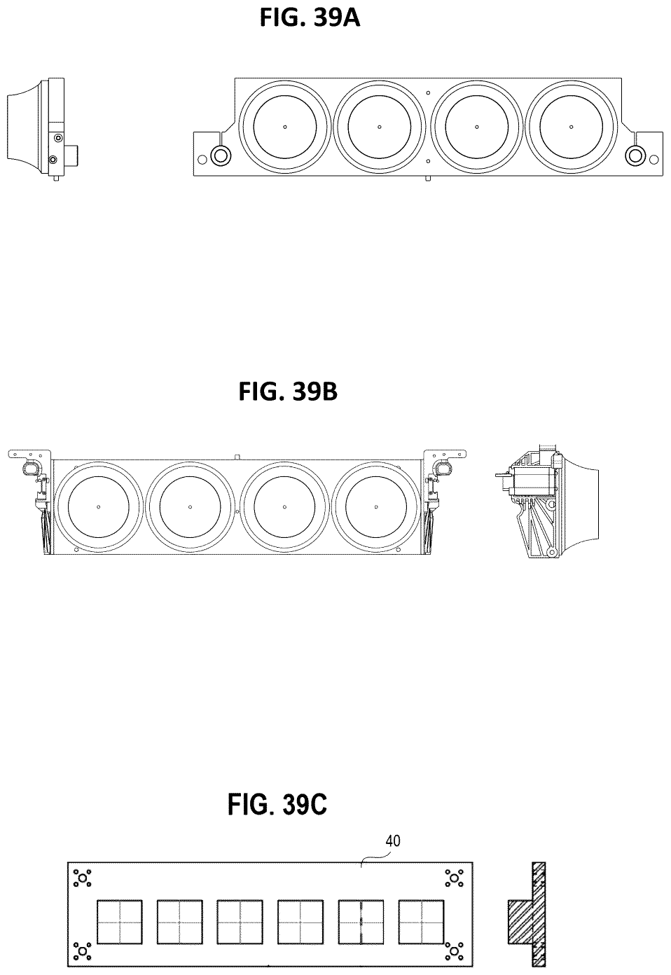

In another embodiment, illustrated in FIGS. 38D-E, cam shafts 808 rotate with the aid of a servo motor 820. The servo motor rotates cam shaft gears 807, which are attached to a cam shaft rod 821 carrying a flap or lob which rotates in a manner that advances the ice along the slats in ice tray 804, also with the aid of gravity. The tray system includes a water gathering tray 809 and outlet 811.

The ice storage system described herein revolutionizes the process of ice storage and organization, offering an automated solution for maintaining a sorted arrangement of ice within storage trays.

In one embodiment, once the ice is completely dried, it is transferred onto ice storage trays 804 via the movement of a mold. These trays may be configured with resin or anti-freeze coatings covering areas where the ice contacts the tray surface, effectively preventing sticking and ensuring easy removal. As the ice pieces are deposited onto the trays, the ice pieces naturally descend along cylindrical paths 810 within the trays under the influence of gravity. Along these paths, strategically positioned levers 806 serve to guide the ice into specific locations within the trays. Each lever is designed to activate upon the settling of ice into a designated position, thereby triggering the movement of the next ice piece to an appropriate distance from the previous one. The movement mechanism of these levers is designed based on the weight distribution of both the lever 806 itself and the ice piece supported thereby. The material composition of the levers is configured to prevent ice adhesion, ensuring smooth operation of the sorting process.

In another embodiment shaped ice released by the molds drops onto tray 805.

Using gravity, the shaped ice moves from tray 805 to sorting tray 804 dropping onto one of the slats on the tray. The cam shaft mechanism is activated using servo motor 820 to rotate cam shaft gears 807 which in turn rotate the cam shaft rods 821 together with the attached cam shafts 806, thereby advancing the shaped ice along the slats to the front of the tray for easy access.

In another mode of operation, the motor mechanism 820 utilizes motorized resin conveyor belts 802 to drive its operation. The motorized conveyor belts 802 are positioned within the mechanism, facilitating the smooth and continuous movement of components, and moved by a shaft 821 connected to the mechanism 820. This mode offers enhanced control and precision, making it ideal for applications requiring consistent and reliable performance. Additionally, the use of resin conveyor belts 802 ensures durability and longevity, even in demanding operating conditions.

This innovative sorting mechanism guarantees that when ice is removed from the bottom of the tray, the ice behind it automatically shifts forward to fill the space, maintaining a sorted arrangement of ice within the tray. By automating the storage and organization of ice, this system enhances efficiency and convenience in ice handling operations.

In an alternative arrangement and embodiment, the ice pieces may be simply be deposited in a bin 860, after being released from the forming molds.

### Water Distribution Flow System

Referring to FIG. 45, an exemplary water flow diagram is illustrated. Water enters the water flow system via an external water source, such as a water line hooked up to a local pressurized water source, which optionally, may be associated with a water filter. A solenoid valve may selectively permit the flow of pressurized water into the system, upon which water is conveyed to a water supply tank. A water conditioning loop may be in fluid communication with the water supply tank, the water conditioning loop comprising a pump for conveying the water through the conditioning loop, a heat exchanger (for example, a liquid to liquid heat exchanger) configured to extract heat from the water, and a flow meter to monitor water flow through the conditioning loop. The water supply tank may also be in fluid communication with one or more water supply lines operatively extending from the water supply tank to one or more molds or mold assemblies, each line having a pump to convey the water to the respective mold or molds assemblies (i.e., Mold 1 and Mold 2). To the extent any excess water is collected during the ice forming process (and/or during cleaning, described below), one or more return lines extending from the one or more molds or mold assemblies to the water supply tank may convey (via a pump) the excess water to the supply tank. A drain line may also extend from the water tank to a local drain.

### Liquid Distribution Flow System

Referring to FIG. 46, an exemplary liquid flow diagram is illustrated. As illustrated, the liquid flow system may be a closed system comprising a liquid tank. As previously described, the cooling liquid and the separation liquid may be the same liquid, in this embodiment, stored in the same liquid tank. A liquid conditioning loop may be in communication with the liquid tank, the liquid conditioning loop comprising a pump for conveying the liquid through the conditioning loop, and a liquid heat exchanger (for example, a gas to liquid heat exchanger, or a liquid to liquid heat exchanger) for cooling and/or heating the liquid, depending on operation of the system in an ice forming mode or an ice separation mode. A water heat exchanger loop may also be in communication with the liquid tank. The water heat exchanger loop may comprise a pump for conveying the liquid through the water heat exchanger loop, wherein the water heat exchanger loop conveys conditioned liquid from the liquid tank through the water heat exchanger to thereby cool the water when the system is operating in an ice making mode.

The liquid tank may also have a liquid supply line extending from the liquid tank to one or more molds or mold assemblies, so as to provide a cooled liquid during operation of the system in an ice making mode, as conditioned by the liquid heat exchanger, or to provide a heated liquid during an ice separation mode, as conditioned by the liquid heat exchanger. The liquid supply line may have a pump to convey the liquid to the respective mold or mold assemblies, along with a flow meter to monitor liquid flow. A plurality of two-way and/or three-way valves may selectively convey the liquid to the mold or mold assemblies and/or through a defrost recirculation line that bypasses the liquid tank.

### Enhanced Cleaning Mechanism for Automatic Ice Creator Units

The system includes an advanced cleaning system designed for the thorough cleaning of Automatic Ice Creator Units, ensuring the removal of bacteria and other contaminants. This system comprises a cleaning solution circulated through the unit to eliminate any buildup or residue.

Referring to FIG. 45, the cleaning process involves initiating the Cleaning Cycle through the ice maker's control panel, followed by the dispensing of the cleaning solution. The solution circulates through the internal components, including the ice mold and water lines, to break down mineral deposits, scale, and impurities. A soaking period may occur to maximize cleaning effectiveness, followed by a rinsing cycle to flush out the solution and debris. Draining mechanisms may remove residual water or solution. After completion, the ice maker may restart normal operations, with additional cycles of clean water recommended to ensure thorough cleansing.

The cleaning process consists of several sequential steps aimed at thorough cleansing of the unit:
1. Initiating the Cleaning Cycle: Users typically activate the automatic cleaning cycle via the ice maker's control panel. Before commencing the cleaning process, users are prompted to ensure that the ice tray is empty.
2. Cleaning Solution Dispensing: The ice maker is equipped with a mechanism to hold a cleaning solution. During the cleaning cycle, the ice maker automatically dispenses the cleaning solution as per predetermined specifications.
3. Circulation and Cleaning: The cleaning solution circulates through the internal components of the ice maker, including the ice mold and water lines. Its purpose is to effectively break down and remove mineral deposits, scale, and other impurities that may have accumulated over time.
4. Soaking Period: Optionally, the cleaning cycle may include a soaking period wherein the cleaning solution remains in contact with the components to maximize its cleaning efficacy.
5. Rinsing: Following the cleaning process, the ice maker may initiate a rinsing cycle to flush out the cleaning solution and any loosened debris. The rinsing cycle ensures that no traces of the cleaning solution remain in the system.
6. Draining
7. Restart and Testing: Upon completion of the cleaning and rinsing cycles, the ice maker may automatically restart and resume normal ice-making operations.

In summary, the Cleaning System for Automatic Ice Creator Units offers an efficient and thorough solution for maintaining cleanliness and hygiene, ensuring the production of safe and contaminant-free ice for various applications.

### Control Mechanism for Ice Production Processes

The system includes an advanced Control System designed to manage the ice-making process. This system incorporates sensors for monitoring ice and water levels, temperature controls, error reporting capabilities, and a timer to regulate freezing and harvesting cycles. Specifically tailored for the production of clear ice, an electronic control board oversees various aspects of the process, including temperature regulation of cooling liquid and water, timing of ice production, management of pumps, motors, and servomotors, and supervision of the ice-melting process to achieve the final ice shape. The control board employs a predefined algorithm to regulate each aspect of clear ice production. The system initiates the ice-making procedure upon meeting predefined conditions, adjusts the ice mold angle, activates vibrator motors at specified intervals, controls water and cooling liquid flow until clear ice formation is complete, and manages the ice-melting process to achieve the final ice shape. Additionally, the system includes mechanisms for ice release and sorting to ensure efficient ice production and collection.

Components of the Control System include:
1. Sensors for Ice and Water Levels: The system incorporates sensors to monitor ice and water levels, providing real-time data for optimal ice production management.
2. Temperature Controls: Temperature regulation is vital for clear ice production. The control system manages the temperature of cooling liquid and water to achieve precise conditions conducive to clear ice formation.
3. Error Reporting: The system is equipped with error reporting capabilities to promptly identify and address any issues that may arise during the ice-making process.
4. Timer for Freezing and Harvesting Cycles: A timer is utilized to regulate freezing and harvesting cycles, ensuring timely and efficient ice production. Also, an ultrasonic sensor or sensors may be utilized to realize completion of ice production, and/or the availability of space for produce more ice.
5. Electronic Control Board for Clear Ice Production: Specifically designed for clear ice production, an electronic control board oversees various aspects of the process. This includes regulating temperature, controlling timing, managing pumps, motors, and servomotors, and supervising the ice-melting process to achieve the final ice shape. A predefined algorithm is employed to control each aspect of clear ice production.

An example of the operation of the Control System involves the following steps:
1. System Initialization: The ice maker displays “STARTING” and checks liquid tank sensors. If any sensor indicates an issue (e.g., empty tanks), appropriate error messages are displayed.
2. Cooling Liquid and Water Preparation: The system ensures that the cooling liquid is at −18±1° C. and water is at 0.5±0.2° C. before commencing the ice-making procedure.
3. Ice-Making Procedure Initiation: Upon meeting predefined conditions, the ice-making procedure is automatically initiated.
4. Ice Mold Adjustment: The ice mold is adjusted to a 15-degree angle to facilitate ice formation.
5. Servo Motor Activation: Servo motors are activated at specified intervals to aid in ice formation.
6. Water and Cooling Liquid Flow: Water and cooling liquid flow into the molds continuously until clear ice formation is complete, controlled by time (around 90 min) or recommended ultrasonic sensors.
7. Clear Ice Formation Completion: Once clear ice is fully formed, the cooling liquid flow is stopped.
8. Ice Melting Process Activation: The ice melting process is activated, involving heating up to 90° C. and initiating the ice release mechanism. The ice-forming mold is adjusted, and the ice-melting process continues until the ice reaches its final shape, controlled by sensors.
9. Ice Release and Sorting: The ice release system is activated to release ice from the molds, directing it to enter the ice sorting system.
10. Controlled Flow of Water and Liquid: Throughout the process, water and liquid flow are controlled by the system to ensure efficient ice production.
11. Ice Collection: The system is designed to ensure that all ices go into trays (62) after defrosting, facilitating efficient ice collection and storage.

In summary, the Control System offers a comprehensive solution for managing the ice-making process, incorporating advanced functionalities to achieve optimal ice production results.

### Process of Ice Final Forming

Controlled Temperature in All Processes: To ensure optimal results, temperature control is essential throughout the various stages of clear ice production.

Controlled Water Stream Temperature: During the water streaming process, the temperature of the water stream is carefully regulated to be near zero degrees Celsius. This temperature control helps promote the formation of clear ice by minimizing impurities and ensuring consistent freezing conditions.

Controlled Mold Temperature: Throughout the clear ice creation process, the temperature of the mold is rigorously controlled. Special attention is given to maintaining the mold at an ideal temperature range, and controlling the rate of temperature change. This temperature control aids in the slow and gradual freezing of the water, allowing impurities to settle and promoting the formation of transparent, clear ice.

Controlled Storage Temperature: Once the clear ice is produced, proper temperature control is crucial during storage to preserve its quality. The clear ice is stored in conditions where the temperature remains consistently below freezing, typically within an optimal temperature range. This controlled storage temperature ensures the integrity and clarity of the clear ice are maintained until it is ready for use.

By implementing precise temperature control throughout these processes, the production of clear ice is optimized, resulting in a high-quality final product.
1. The ice maker uses a cooling food-grade (for example, Propylene Glycol Food Grade mixed with 50% water) liquid to cool the molds.
2. The ice maker pre-cools the water before beginning the ice production process.
3. The ice maker utilizes at least one water tank to enhance the ice production speed.
4. The ice maker creates a consistent water flow on the mold's surface, descending from top to bottom, to produce transparent ice.
5. The ice maker creates consistent water pressure on the mold's surface by employing a pipe with numerous perforations along its surface and several Y-shaped fins within the tube. This configuration guarantees consistent, uniform water flow throughout the entire mold.
6. The ice maker maintains a water flow rate on the mold of approximately 2 liters per minute, depending on the number of molds in the assembly.
7. The ice maker defines the stream of water flow on the mold and outlining the internal flow creation within the mold.
8. The ice maker establishes a zero-degree temperature range (between 0 to 0.7 degrees Celsius) for the incoming water onto the mold.
9. The ice maker sets the mold at a predetermined angular orientation during ice production (e.g., 15 degrees), for example when forming spherical ice pieces.
10. The ice maker has defined mold shapes and the profile of its inner surface.
11. The ice maker defines the mechanism and mold design type for producing clear ice.
12. The ice maker provides circulation of cooling liquid within the mold and the spiral shape of the cooling liquid's circulation path within the mold.
13. The ice maker includes entry and exit points of the cooling liquid from the mold.
14. The ice maker includes a mold rotation system and movement mechanism, encompassing rotational movements for placement of the molds in specific angular positions.
15. The ice maker may be used to execute a method of final ice shaping to achieve the final shape, utilizing a metal mold with a specialized profile. The Ice mold is adjusted in a special position allowing the forming mold to bring the ice to its final shape, for example by melting the ice.
16. The ice maker controls the coolant temperature during the process.
17. The ice maker includes the system for separating ice from the mold, including a separate liquid tank at ambient or heated temperatures, a pump, and valves. This system, by replacing the cooling liquid, with ambient or heated temperature liquid raises the mold's surface temperature, and through rotation, separates the ice from the mold utilizing the weight of the ice piece.
18. The ice maker encompasses a process of sorting ice into trays and its subsequent storage.
19. The ice maker encompasses the ice storage tray, and internal temperatures of 0 to-15 degrees Celsius.

Although the present disclosure has been described with reference to preferred embodiments, those skilled in the art will recognize that changes may be made in form and detail without departing from the spirit and scope of the disclosure. As such, it is intended that the foregoing detailed description be regarded as illustrative rather than limiting and that it is the appended claims, including all equivalents thereof, which are intended to define the scope of the invention.

### LIST OF REFERENCE NUMBERS

2: (longitudinal direction)
4: (lateral direction)
8: (ice maker/ice maker machine)
10: (ice forming mold/forming molds)
12: (mold body/body)
14: (forming member)
16: (mold surface)
18: (cavity)
20: (laterally extending axis)
22: (first interior portion)
24: (second portion)
26: (peripheral lip portion)
28: (fluid conduit)
30: (fluid input)
32: (fluid output)
34: (overall fluid supply/input)
36: (overall fluid outlet)
40: (mold assembly)
42: (water inlet)
44: (nozzles/outlets)
50: (water supply system)
52: (water supply tank)
54: (water heat exchanger)
56: (mold water inlet)
60: (water pressure breakers)
62: (tray/water collection tray)
65: (water outlet)
70: (ice shaping mold)
71: (logo or emblem placement feature)
72: (second mold surface/mold surface)
74: (outer concave surface)
76: (second cavity)
78: (aperture)
80: (ice piece shape)
82: (circular knife edge)
90: (electrical heating system)
94: (finished ice piece)
100: (horizontal axis)
102: (mold positioning system)
104: (base)
106: (plates)
108: (fluid output port)
110: (water input port)
114: (fluid input port)
120: (transmission)
122: (gears)
124: (servo motor)
125: (splash guard/water lead)
126: (driven gear)
600: (spiral)
602: (first forming mold portion/assembly)
603: (housing body)
604: (second mold portion/assembly)
606: (water collection reservoir)
608: (first volume-regulating wall)
609: (second volume-regulating wall)
610: (channels)
611: (third volume-regulating wall)
613: (vents)
640: (sliders)
680: (linear motion motors or actuators)
700: (ice-drying system)
702: (fans)
704: (refrigeration system/cooling radiator)
800: (ice storage system)
802: (motorized resin conveyor belts)
804: (trays)
805: (tray/ramp)
806: (levers)
807: (pins/cam shaft gears)
808: (cam shafts)
809: (water gathering drain)
810: (cylindrical paths)
811: (outlet)
820: (servo motor)
821: (cam shaft rod)
860: (bin)
870: (rotary coupling)

1. An ice maker comprising:
an ice forming mold comprising a first mold surface defining a first cavity opening outwardly when the ice forming mold is in an ice forming position, and a fluid conduit configured to carry a fluid for cooling the first mold surface;
a water outlet positioned above the first mold surface, wherein the water outlet is configured to stream water over the first mold surface; and
a heatable shaping mold comprising a second mold surface defining a second cavity, wherein one or both of the shaping mold and the ice forming mold are moveable relative to each other when the ice forming mold is in the ice forming position, wherein the shaping mold is spaced apart from the ice forming mold, to a shaping position, wherein the shaping mold and the ice forming mold are abutted such that the second cavity of the shaping mold and the first cavity of the ice forming mold define an ice piece shape.

2. The ice maker of claim 1 wherein the fluid conduit is further configured to carry a fluid for raising a temperature of the first mold surface.

3. The ice maker of claim 1 wherein an interior first portion of the first mold surface comprises a concave shape.

4. The ice maker of claim 3 wherein at least a portion of the first cavity has a hemispherical shape defined by the concave shape of the first portion of the first mold surface.

5. The ice maker of claim 3 wherein the concave shape comprises a first concave shape and the second mold surface comprises a second concave shape, and wherein the hemispherical shape comprises a first hemispherical shape and the second cavity comprises a second hemispherical shape facing the first hemispherical shape.

6. The ice maker of claim 5 wherein a second portion of the first mold comprises a convex shape defining at least in part a mouth of the first mold.

7. The ice maker of claim 6 wherein the fluid conduit comprises a fluid input and a fluid output, and wherein the fluid conduit spirals around the first mold surface between the fluid input and the fluid output.

8. The ice maker of claim 1 wherein the fluid is a food grade liquid.

9. The ice maker of claim 1 wherein the first mold is rotatable about a horizontal axis.

10. The ice maker of claim 9 wherein the first cavity is defined by a laterally extending central axis that is orthogonal to the horizontal axis, wherein the central axis is oriented upward between 5 degrees and 50 degrees when the ice forming mold is in the ice forming position.

11. The ice maker of claim 10 wherein the central axis is oriented downward between −50 degrees and −135 degrees when the ice forming mold is moved to an ice removal position.

12. An ice maker comprising:
an ice forming mold comprising:
a first mold surface comprising a first portion defining a hemispherical shape opening laterally outwardly and a second portion having a convex shape; and
a fluid conduit configured to carry a fluid for cooling the first mold surface; and
a water outlet positioned above the first mold surface, wherein the water out is configured to stream water over the first mold surface.

13. The ice maker of claim 12 wherein the hemispherical shape comprises a first hemispherical shape, and further comprising a heatable shaping mold comprising a second mold surface defining a second hemispherical shape, wherein one or both of the shaping mold and the ice forming mold are moveable relative to each other from an ice forming position, wherein the shaping mold is spaced apart from the ice forming mold, and a shaping position, wherein the shaping mold and the ice forming mold are abutted such that the first and second hemispherical shapes define a sphere.

14. The ice maker of claim 12 wherein the fluid conduit is further configured to carry a fluid for raising a temperature of the first mold surface.

15. The ice maker of claim 12 wherein the fluid conduit comprises a fluid input and a fluid output, and wherein the fluid conduit spirals around the first mold surface between the fluid input and the fluid output.

16. The ice maker of claim 12 wherein the first mold is rotatable about a horizontal axis.

17. A method of making ice pieces comprising:
orienting an ice forming mold in an ice forming position, wherein the ice forming mold comprises a first mold surface defining a first cavity opening laterally outwardly;
circulating a cooled fluid through a conduit and thereby cooling the first mold surface with the cooled fluid;
streaming cold water over the first mold surface;
forming a formed ice piece on the first mold surface of the ice forming mold;
pressing a heated shaping mold against the formed ice piece and thereby melting the formed ice piece to define a finished ice piece;
moving the heated shaping mold away from the finished ice piece;
heating the ice forming mold;
rotating the ice forming mold; and
releasing the finished ice piece from the ice forming mold.

18. The method of claim 17 wherein the first mold surface comprises a first portion defining a first hemispherical shape and a second portion having a convex shape, and wherein the heated shaping mold comprises a second mold surface defining a second hemispherical shape, wherein the finished ice piece has a spherical shape.

19. The method of claim 17 wherein heating the ice forming mold comprises circulating a heated fluid through the conduit.

20. The method of claim 17 wherein the first cavity is defined by a laterally extending axis, wherein the axis is oriented between 5 degrees and 50 degrees when the ice shaping mold is in the ice forming position.
